(19) United States
(12) Patent Application Publication
(10) Pub. No.: US 2026/0169684 A1
(43) Pub. Date: Jun. 18, 2026

(54) MULTIMODAL INPUTS

(71) Applicant: Google LLC, Mountain View, CA (US)

(72) Inventors: Kevin Gaunt, San Francisco, CA (US); Ishac Bertran, Brooklyn, NY (US); Philip Dam Roadley-Battin, Oslo (NO); Matias Gonzalo Duarte, Los Altos Hills, CA (US); Jason Briggs Cornwell, Lafayette, CA (US); Roger William Graves, San Carlos, CA (US); Matthew Sibigtroth, Urbana, IL (US); Gaetano Ling, Mountain View, CA (US); Jochen Weber, San Francisco, CA (US); Tobias Toft, San Mateo, CA (US); Michelle Alvarez, Oakland, CA (US); John Paul Benvenuto, Palm Springs, CA (US)

(21) Appl. No.: 19/423,531

(22) Filed: Dec. 17, 2025

Related U.S. Application Data
(60) Provisional application No. 63/735,764, filed on Dec. 18, 2024.

(51) Int. Cl. G06F 3/16; G06F 3/01; G06F 3/04883

(52) U.S. Cl. CPC G06F 3/167; G06F 3/017; G06F 3/04883

(57) ABSTRACT

A computing system receives indications of a natural language user input and an image input in response to detecting at least one gesture. The natural language user input may indicate a command for performing a task. The at least one gesture may be a single, continuous gesture. The computing system identifies at least one application including functionality for performing the task by applying a machine learning model to the indications of the natural language user input and the image input. The computing system generates, for display, output associated with the at least one application. The output may include a graphical component associated with the at least one application or a suggested action for the at least one application. The computing system may execute, based on the indications of the natural language user input and the image input, the at least one application to perform the task.

This application claims priority to U.S. Provisional Patent Application No. 63/735,764, entitled “MULTIMODAL INPUTS,” filed Dec. 18, 2024, which is incorporated by reference in its entirety herein.

### BACKGROUND

Computing devices may include a display device that displays content from one or more applications executing at the computing device. A user may interact with a graphical user interface (GUI) of an application using a presence-sensitive screen (e.g., touchscreen) of the computing device to enter and/or capture input, such as interacting with a camera application GUI to capture an image or interacting with a web browser application GUI to enter a textual search query. However, to provide multiple types of inputs for performing a single task, users may have to switch between multiple applications and/or GUIs to gather or capture such inputs.

### SUMMARY

In general, aspects of this disclosure are directed to techniques for receiving multimodal input and applying a large language model to the multimodal input to generate outputs associated with one or more applications. An example computing system may output, for display at a display device (e.g., a mobile device screen), a graphical user interface (GUI), such as a universally accessible interactive button, which may be displayed, e.g., on a home screen. A user may perform one or more gestures (e.g., by interacting with the universally accessible button with their finger) to provide multimodal input. For example, the user may perform a first gesture to provide an indication of a natural language input that indicates a command for performing a task. Thus, in some examples, the universally accessible button may include a “touch and talk” capability. The user may perform one or more additional gestures to provide an indication of an image input. In some examples, the first gesture and the one or more additional gestures may each be part of a single, continuous gesture. That is, without lifting their finger, the user may provide “multimodal” input, e.g., natural language input and an image input, to the computing system, which the computing system may use to generate output for performing the task. For example, the computing system may identify at least one application including at least one function for performing the task by applying a machine learning model (e.g., large language model) to the multimodal input. The computing system may then generate, for display at a display device (e.g., the mobile device screen), at least one output associated with the at least one application. In some examples, the at least one output may include GUIs (e.g., widgets) for multiple associated applications, which may be presented within a single frame of the user's screen, and may be positioned based on a respective level of relevance. That is, a user may provide multimodal input, and the computing system may output relevant associated application graphical components that may help perform the user's task.

In one example, the disclosure is directed to a method that includes, responsive to detecting at least one gesture, receiving, by a computing system, an indication of a natural language user input and an indication of an image input, wherein the natural language user input indicates a command for performing a task. The method further includes identifying, by the computing system, at least one application including at least one function for performing the task by applying a machine learning model to the indication of the natural language user input and the indication of the image input, and generating, by the computing system and for display at a display device, at least one output associated with the at least one application.

In another example, the disclosure is directed to a computing system that includes at least one processor, a display device, and at least one storage device that stores instructions. The instructions, when executed by at least one processor, cause the at least one processor to, responsive to detecting at least one gesture, receive an indication of a natural language user input and an indication of an image input, wherein the natural language user input indicates a command for performing a task. The instructions further cause the at least one processor to identify at least one application including at least one function for performing the task by applying a machine learning model to the indication of the natural language user input and the indication of the image input, and generate, for display at the display device, at least one output associated with the at least one application.

In another example, the disclosure is directed to a non-transitory computer-readable storage medium storing instructions. The instructions, when executed by at least one processor, cause the at least one processor to, responsive to detecting at least one gesture, receive an indication of a natural language user input and an indication of an image input, wherein the natural language user input indicates a command for performing a task. The instructions further cause the at least one processor to identify at least one application including at least one function for performing the task by applying a machine learning model to the indication of the natural language user input and the indication of the image input, and generate, for display at a display device, at least one output associated with the at least one application.

In another example, the disclosure is directed to a computer program product for generating output based on received multimodal input. The computer program product comprises instructions that, when executed by at least one processor, cause the at least one processor to, responsive to detecting at least one gesture, receive an indication of a natural language user input and an indication of an image input, wherein the natural language user input indicates a command for performing a task. The instructions further cause the at least one processor to identify at least one application including at least one function for performing the task by applying a machine learning model to the indication of the natural language user input and the indication of the image input, and generate, for display at a display device, at least one output associated with the at least one application.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example computing system for receiving multimodal input, in accordance with one or more aspects of the present disclosure.

FIG. 2 is a block diagram illustrating another example computing system for receiving multimodal input and applying a large language model to the multimodal input to generate output associated with one or more applications, in accordance with one or more aspects of the present disclosure.

FIG. 3A is a conceptual diagram illustrating an example training process for a machine learning module, in accordance with one or more techniques of this disclosure.

FIG. 3B is a conceptual diagram illustrating an example trained machine learning module, in accordance with one or more techniques of this disclosure.

FIG. 3C is a conceptual diagram illustrating a machine learning module configured to apply a large language model to various multimodal inputs to generate outputs associated with one or more applications, in accordance with one or more aspects of the present disclosure.

FIG. 4 is a conceptual diagram illustrating an example of output associated with one or more applications, in accordance with one or more aspects of the present disclosure.

FIG. 5 is a conceptual diagram illustrating another example of output associated with one or more applications, in accordance with one or more aspects of the present disclosure.

FIG. 6 is a flowchart illustrating example operations for receiving multimodal input and applying a large language model to the multimodal input to generate outputs associated with one or more applications, in accordance with one or more aspects of the present disclosure.

Like reference characters denote like elements throughout the text and figures.

### DETAILED DESCRIPTION

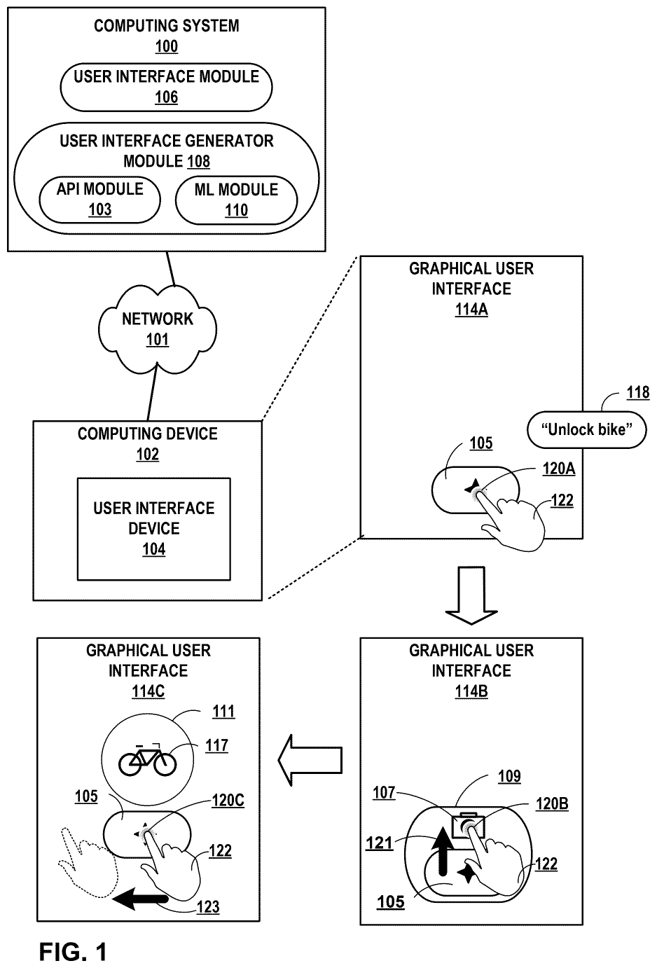

FIG. 1 is a conceptual diagram illustrating an example computing system for receiving multimodal input, in accordance with one or more aspects of the present disclosure. In the example of FIG. 1, a user 122 interacts with computing device 102 that is in communication with computing system 100. In some examples, some or all of the components and/or functionality attributed to computing system 100 may be implemented on or performed by computing device 102. That is, in some examples, the techniques described herein may be implemented by computing device 102, e.g., “on-device.”

In some examples, computing device 102 may be, but is not limited to, a portable, mobile, or other device, such as a mobile phone (including a smartphone), a laptop computer, a desktop computer, a tablet computer, a smart television platform, a server computer, a mainframe, a gaming system, a media player, an e-book reader, an automobile navigation system, a virtual reality device, an augmented reality device, a wearable computing device (e.g., a computerized watch, computerized eyewear such as AI glasses, a computerized glove, a computerized ring, etc.), or any other type of mobile or non-mobile computing device. While not explicitly shown in the example of FIG. 1, computing system 100 may be implemented on a plurality of computing devices. In some examples, computing system 100 may represent a cloud computing system that provides one or more services via network 101. That is, in some examples, computing system 100 may be a distributed computing system.

Computing system 100 may communicate with computing device 102 via network 101. Network 101 may include any public or private communication network, such as a cellular network, Wi-Fi network, a direct cell-to-satellite communication network, or other type of network for transmitting data between computing system 100 and computing device 102. In some examples, network 101 may represent one or more packet switched networks, such as the Internet. Computing device 102 may send and receive data to and from computing system 100 across network 101 using any suitable communication techniques. For example, computing system 100 and computing device 102 may each be operatively coupled to network 101 using respective network links. Network 101 may include network hubs, network switches, network routers, etc., that are operatively inter-coupled thereby providing for the exchange of information between computing device 102 and computing system 100. In some examples, network links of network 101 may be Ethernet, ATM or other network connections. Such connections may include wireless and/or wired connections.

Computing device 102 may include one or more user interface devices (“UID”) 104. UID 104 of computing device 102 may be configured to function as input devices and/or output devices for computing device 102. UID 104 may be implemented using various technologies. For instance, UID 104 may be configured to receive input from user 122 through tactile, audio, and/or video feedback. Examples of input devices include a presence-sensitive display, a presence-sensitive or touch-sensitive input device (such as that shown in FIG. 1), a mouse, a keyboard, a voice responsive system, video camera, microphone or any other type of device for detecting a command from user 122. In some examples, a presence-sensitive display includes a touch-sensitive or presence-sensitive input screen, such as a resistive touchscreen, a surface acoustic wave touchscreen, a capacitive touchscreen, a projective capacitive touchscreen, a pressure sensitive screen, an acoustic pulse recognition touch screen, or another presence-sensitive technology. That is, UID 104 of computing device 102 may include a presence-sensitive device that may receive tactile input from user 122. In general, UID 104 may detect gestures as input from user 122. UID 104 may receive indications of the tactile input by detecting one or more gestures from user 122 (e.g., when user 122 touches or points to one or more locations of UID 104 with a finger or a stylus pen).

UID 104 may additionally or alternatively be configured to function as an output device by providing output to user 122 using tactile, audio, or video stimuli. Examples of output devices include a sound card, a video graphics adapter card, or any of one or more display devices, such as a liquid crystal display (LCD), dot matrix display, light emitting diode (LED) display, microLED, miniLED, organic light-emitting diode (OLED) display, e-ink, or similar monochrome or color display capable of outputting visible information to user 122. Additional examples of an output device include a speaker, a haptic device, or other device that can generate intelligible output to a user. UID 104 may present the output as a graphical user interface (GUI) (e.g., any one of GUIs 114A, 114B, and GUI 114C, which may be referred to herein collectively as “GUIs 114”), which may be associated with functionality provided by computing device 102. For example, UID 104 may present various user interfaces (e.g., GUIs associated with a lock screen GUIs, home screen GUIs, software application GUIs, camera input GUIs, input text box GUIs, input audio GUIs, etc.) of components of a computing platform, operating system, applications, or services executing at or accessible by computing device 102. A user may interact with a respective user interface to cause computing device 102 to perform operations relating to a function.

In some examples, UID 104 of computing device 102 may detect two-dimensional and/or three-dimensional gestures as input from user 122. For instance, a sensor of UID 104 may detect the user's movement (e.g., moving a hand, an arm, a pen, a stylus, etc.) within a threshold distance of the sensor of UID 104. UID 104 may determine a two-or three-dimensional vector representation of the movement and correlate the vector representation to a gesture input (e.g., a hand-wave, a pinch, a clap, a pen stroke, etc.) that has multiple dimensions. In other words, UID 104 may, in some examples, detect a multidimensional gesture without requiring the user to gesture at or near a screen or surface at which UID 104 outputs information for display. Instead, UID 104 may detect a multi-dimensional gesture performed at or near a sensor which may or may not be located near the screen or surface at which UID 104 outputs information for display.

In the example of FIG. 1, computing system 100 includes user interface (UI) module 106. UI module 106 may perform operations described herein using hardware, software, firmware, or a mixture thereof residing in and/or executing at computing system 100. Computing system 100 may execute module 106 with one processor or with multiple processors. In some examples, computing system 100 may execute module 106 as a virtual machine executing on underlying hardware. Module 106 may execute as one or more services of an operating system or computing platform or may execute as one or more executable programs at an application layer of a computing platform. UI module 106, as shown in the example of FIG. 1, may be operable by computing system 100 to perform one or more functions, such as receive input and send indications of such input to other components associated with computing system 100. UI module 106 may also receive data from components associated with computing device 102. Using the data received, UI module 106 may cause other components associated with computing device 102, such as UID 104, to provide output based on the data.

In general, UI module 106 may process user interactions with UID 104 and other components of computing device 102. UI module 106 may act as an intermediary between various components of computing device 102 to make determinations based on indications of user inputs detected by UID 104 and generate output at UID 104 in response to the user inputs. UI module 106 may receive instructions from an application, service, platform, or other module of computing system 100 and/or computing device 102 to cause UID 104 to output GUIs, such as GUIs 114. GUIs 114 may include data output, from UI module 106 and via UID 104, according to instructions stored at an operating system of computing device 102, a software application of computing device 102, or the like.

UI module 106, according to the techniques described herein, may manage multimodal input provided by user 122 operating computing device 102. In some examples, UI module 106 may initiate an action (e.g., by outputting data to computing device 102) of prompting user 122 to provide multimodal input data (e.g., text, voice, images, files, etc.) based on gestures associated with locations (e.g., locations 120A, 120B, 120C, which may be referred to herein collectively as “locations 120”), path 121 and/or transition 123 at GUIs 114. UI module 106 may receive indications of user inputs associated with locations 120, paths 121, and/or transition 123 (e.g., gestures provided by user 122) and may update a GUI in response to processing the indications of the user inputs. That is, GUIs 114 may be considered different views of a single GUI, e.g., a home screen GUI, that is updated or transitions based on the gestures provided by user 122.

In general, user 122 may be provided with an opportunity to provide input to control whether programs or features of computing device 102 and/or computing system 100 can collect and make use of user information (e.g., user 122's personal data, information about user 122's current location, location history, activity, etc.), or to dictate whether and/or how computing device 102 and/or computing system 100 may receive content that may be relevant to user 122. Other user information may include data that includes the context of user usage, either obtained from an application itself or from other sources. Examples of usage context may include breadth of share (sharing publicly, or with a large group, or privately, or a specific person), context of share, etc. When permitted by the user, additional data can include the state of the device, e.g., the location of the device, the apps running on the device, etc. In addition, certain data may be treated in one or more ways before it is stored or used by computing device 102 and/or computing system 100 so that personally identifiable information is removed. For example, a user's identity may be treated so that no personally identifiable information can be determined about the user, or a user's geographic location may be generalized where location information is obtained (such as to a city, ZIP code, or state level), so that a particular location of a user cannot be determined. Thus, user 122 may have control over how information is collected about them and used by computing device 102 and/or computing system 100. For example, user 122 may be prompted by computing device 102 to provide explicit consent for computing device 102 and/or computing system 100 to retrieve and/or store any or all of user 122's data. In some examples, an action log executed on computing device 102 may provide user 122 a ledger of activity, which may show any automations or applications running in the background of computing device 102, as well as an accurate log of all computing system 100 activity.

In accordance with the techniques described herein, computing system 100 may receive multimodal input in response to detecting at least one gesture from a user. That is, user 122 may provide one or more gestures that are detected at locations 120 of GUIs 114, which may cause computing system 100 to receive simultaneous indications of input, such as an indication of a natural language input 118 and an indication of an image input 117.

In the example of FIG. 1, computing system 100 may output, for display at computing device 102 via UID 104, data for a first GUI, such as GUI 114A that includes button 105. GUIs 114A, 114B, and 114C may each represent one view of a device home screen. GUIs 114 may include visual data, displayed via UID 104, associated with the home screen, or in some other examples, a lock screen, a software application GUI, or other GUI displayed by UID 104 during operation of computing device 102. For example, in some examples, GUIs 114 may represent different views of a GUI for an application installed on computing device 102. In the example of FIG. 1, GUI 114A may be considered a first view of a home screen GUI, in which GUI 114A includes a first UI component, such as button 105, which may be considered a “universally accessible” button. That is, in general, the techniques described herein may provide a unified system including some or all of the components of computing device 102 and/or computing system 100, which may be accessible to users through a consistent entry point (such as button 105) that may be displayed to users on a lock screen, home screen, and/or on any screen for an application installed on the user's device. In general, although the techniques described herein provide examples of multimodal input including natural language input and image input, in general, the single entrypoint may receive various types of data as input, e.g., text input, audio input, image input, screen content (e.g., information indicative of the content on a user's current screen), file uploads, and/or combinations thereof (i.e., multimodal input including various types of input).

In some examples, button 105 may be considered a “zero state” UI element that may be displayed via UID 104 at a point in time prior to receiving an indication of the first user input. That is, button 105 may be a button that frequently or permanently overlays one or more GUIs displayed by UID 104, such that user 122 may eventually interact with button 105 while viewing the one or more GUIs. For example, in some examples, such as the example of FIG. 1, button 105 may be positioned at a bottom portion of a device home screen. In some examples, user 122 may interact with UI elements (e.g., application widgets) displayed on the home screen (not shown in FIG. 1) to open an application installed on computing device 102. UID 104 may then present a GUI for the application, in which button 105 may overlay the application GUI. As such, button 105 may be displayed while user 122 navigates between various GUIs (e.g., a home screen and GUIs for multiple applications).

In general, button 105 may enable user 122 to provide one or more indications of one or more multimodal inputs via a single, continuous gesture, such as a single, continuous, tactile event. In the example of FIG. 1, user 122 may perform a first tactile event corresponding to location 120A of GUI 114A. For example, the first tactile event may be a press tactile event, e.g., user 122 may press button 105 with their finger at location 120A. UI module 106 of computing system 100 may receive an indication of the first tactile event. In some examples, when user 122 performs the first tactile event, user 122 may also provide a first user input, such as natural language input 118.

That is, computing system 100 may be configured to receive an indication of natural language input 118 based on, for example, a “touch and talk” feature. More specifically, computing system 100 may receive the indication of natural language user input 118 from computing device 102 in response to a gesture detected at a location of a presence-sensitive display of computing device 102, e.g., location 120A that corresponds to button 105 used for causing computing system 100 to perform the techniques described herein. For example, while holding down on button 105, user 122 may provide natural language input 118 such as, “Unlock bike,” in which holding down on button 105 may be a gesture that causes a UID 104 (e.g., a microphone) of computing device 102 to capture natural language input 118. Computing system 100 may receive an indication of natural language input 118.

Responsive to receiving the indication of the first tactile event, UI module 106 of computing system 100 may output, for display at computing device 102 via UID 104, data for one or more additional GUIs. For example, in the example of FIG. 1, UI module 106 may output data for second GUI 114B, which may be a second view of the device home screen, and may include a second UI component, such as widget 109. That is, in the example of FIG. 1, while user 122 is pressing down on button 105, data output from UI module 106 may cause GUI 114A to transition to GUI 114B, in which button 105 may transition to widget 109. Widget 109 may include a plurality of UI elements (e.g., icons, labels, a checkbox, text, a text entry field, etc.), in which each UI element from the plurality of UI elements may be associated with an action, e.g., an input action, such as one or more of recognizing data objects displayed in the first graphical user interface, receiving an audio input, receiving an image input, receiving a file input, receiving a text input, or executing an application from the one or more applications. For example, as shown in the example of FIG. 1, GUI 114B may include UI element 107, which may be an icon associated with a camera device for capturing image input. GUI 114B and/or widget 109 may include additional icons associated with the aforementioned actions that are not shown in the example of FIG. 1.

User 122 may select a UI element included in GUI 114 by performing a second tactile event, such as a swipe tactile event. That is, in the example of FIG. 1, user 122 may select UI element 107 via a swipe-up tactile event, in which user 122 may drag their finger from location 120A to location 120B in the direction of path 121. That is, the first tactile event and second tactile event performed by user 122 may each be considered part of a single, continuous tactile event.

UI module 106 of computing system 100 may receive an indication of the second tactile event. Responsive to receiving the indication of the second tactile event, UI module 106 may output, for display at computing device 102 via UID 104, data for a third GUI 114C, in which GUI 114C may include a visual indication of the respective action associated with the selected UI element. That is, in the example of FIG. 1, while user 122 is still holding down their finger, GUI 114C may be presented and may include visual indication 111 of the respective action associated with selected UI element 107, which may be an icon associated with a camera device for capturing image input. As such, visual indication 111 may be a window for capturing, e.g., via a device camera included in computing device 102, an image 117, which in this example, may be a bike. In some examples, location 120B and 120C may be the same location, in which UI element 107 of GUI 114B may transition to button 105 of GUI 114C while user 122 is pressing down with their finger at location 120B/120C. In some other examples, rather than button 105, GUI 114C may include a different button, such as a button including UI element 107, e.g., a camera icon.

User 122 may provide a last tactile event, e.g., a termination event, such as lifting their finger off the screen, which is represented by transition 123 in FIG. 1. That is, to capture image input 117 (e.g., an image of the bike, which may include a code for unlocking the bike (not shown in FIG. 1) via a bike rental application), user 122 may lift their finger off of button 105 at location 120C. Then, the camera device may capture image input 117, in which computing system 100 may then receive an indication of image input 117. As such, computing system 100 may receive various multimodal inputs, such as natural language input 118 and image input 117, during a single, continuous tactile event. That is, the first tactile event (e.g., user 122 pressing down on button 105 of GUI 114A at location 120A for the first time), the second tactile event (e.g., user 122 dragging their finger from location 120A to location 120B via path 121, in which location 120B corresponds to UI element 107 of GUI 114B), and third tactile event (e.g., user 122 providing a termination event by lifting their finger off of their screen) may each be considered part of a single, continuous tactile event that causes computing system 100 to receive natural language input 118 and image input 117.

Computing system 100 may include UI generator module 108, which may further include application programming interface (API) module 103 and machine learning module 110. UI generator module 108 may receive various multimodal inputs and other information from computing device 102 to generate outputs associated with one or more applications. In general, the one or more applications may be one or more software applications installed on computing device 102, and may include functionality to perform any variety of operations on computing device 102. In general, each application from the one or more applications may include a “plurality of functions,” which may be functions, or functionality, e.g., capabilities or features of an application, that are provided by the values, settings, or other data that are directly embedded into the source code of an application, rather than those that are dynamically generated or configurable at runtime. The “plurality of functions” may include functionality provided by values, logic, etc. that are fixed, e.g., “hard-coded”, in an application's source code, and cannot be easily changed without modifying the code itself. As such, the “plurality of functions” may be considered statically defined functions, or functions that are predefined at compile time or build time and do not change during execution. In some examples, computing system 100 may retrieve, via API module 103, information associated with the plurality of functions, which may refer to data that can be retrieved, e.g., via an API, from the one or more applications installed on computing device 102. For example, an application may include an API that enables external applications or modules to interact with and use the data stored by the application. As such, the “information associated with a plurality of functions included in one or more applications” may be defined as data associated with the predefined or statically defined functionality of the one or more applications, e.g., an API response. As an example, a bike rental application may include predefined or statically defined functionality for an input entry field that accepts a unique code for renting an associated bike. API module 103 may use the bike rental application API to provide input and/or retrieve the information associated with the plurality of functions, which may include, for example, data for GUIs and/or graphical components associated with the bike rental application. For example, the bike rental application may have an API endpoint configured to accept input images, such as input image 117 that, in this example, may include a unique code (e.g., QR code) to unlock a bike. API module 103 may submit image 117 as part of an API request, in which the bike rental application may then process input image 117 and return a response back to API module 103, which may indicate whether the bike can be unlocked. That is, API module 103 may receive information associated with the functionality of the bike rental application, e.g., graphical components and GUIs, but may not receive all of the actual code or logic that provides the functionality of the application, e.g., the code or logic for determining whether a bike can be unlocked based on the submitted QR code image.

Computing system 100 may apply machine learning module 110, which may employ one or more machine learning models (e.g., a large language model) to the indications of image input 117 and the natural language user input 118 to generate one or more outputs associated with one or more applications. Continuing the example above, using the information retrieved from API module 103, machine learning module 110 may determine, based on natural language input 118 that includes the “Unlock bike” command and input image 117 that includes an image of the bike, the associated bike rental application. Then, in some examples, machine learning module 110 may generate data for a GUI associated with a function for performing a task. For example, using the information retrieved from API module 103, machine learning module 110 may generate data for a GUI associated with the bike rental application, which may be a GUI associated with the task of unlocking the bike. That is, API module 103 may provide input to an application to have the task be performed, and machine learning module 110 may generate data for an associated GUI that indicates the task was performed.

As such, the techniques described in this disclosure may enable users to seamlessly provide multimodal inputs through a single, continuous tactile event (e.g., including a combination of a press action, swipe actions, a lift off action, etc.) detected at locations of one or more GUIs. That is, to perform various tasks or receive various outputs (e.g., application GUIs for performing tasks, suggested search queries, relevant application results for a user query, etc.) users may not be required to switch between multiple applications to gather information and/or input, and instead may provide multimodal input through a single, universally accessible button. As such, users may be provided a “shortcut” for performing various tasks, e.g., tasks that require inputting various types of information and/or navigating through one or more applications installed on the user's device. In this way, the techniques described in this disclosure may help users perform tasks more efficiently, and thus improve overall user experience with devices.

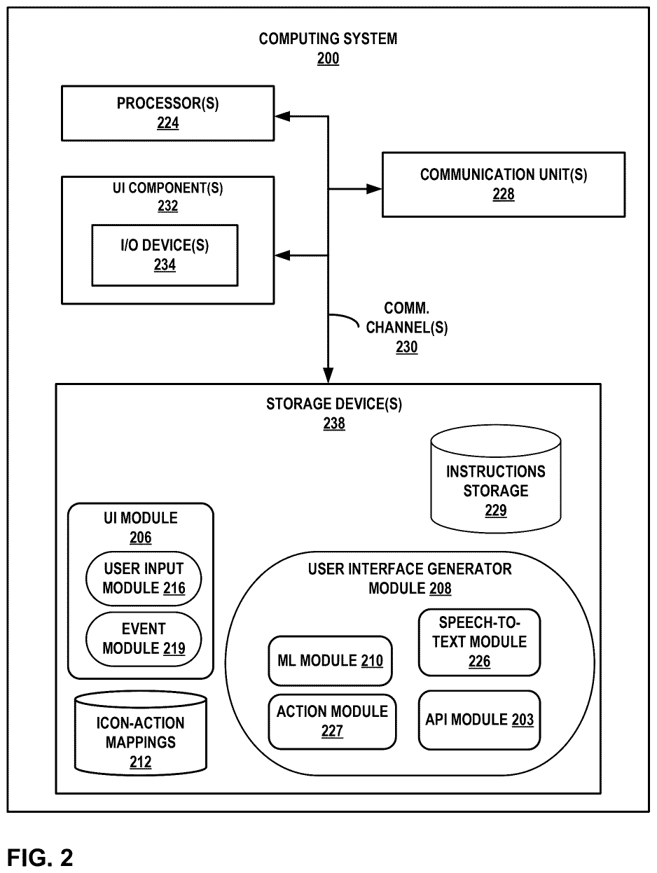

FIG. 2 is a block diagram illustrating another example computing system for receiving various multimodal inputs and applying a large language model to the multimodal inputs to generate outputs associated with one or more applications, in accordance with one or more aspects of the present disclosure.

As shown in the example of FIG. 2, computing system 200 includes processors 224, one or more communication channels 230, one or more user interface components (UIC) 232 including input/output (I/O) devices 234, one or more communication units 228, and one or more storage devices 238. Storage devices 238 of computing system 200 may include icon-action mappings 212, UI module 206, which may further include user input module 216 and event module 219, and UI generator module 208. As shown in the example of FIG. 2, UI generator module 208 further includes API module 203, machine learning module 210, speech-to-text module 226, and action module 227.

Some or all of the components and/or functionality attributed to computing system 200 may be implemented or performed by a computing device in communication with computing system 200. Computing system 200, UI module 206, UI generator module 208, API module 203, and machine learning module 210 may be similar if not substantially similar to computing system 100, user interface module 106, user interface generator module 108, API module 103, and machine learning module 110 of FIG. 1, respectively.

The one or more communication units 228 of computing system 200, for example, may communicate with external devices by transmitting and/or receiving data at computing system 200, such as to and from remote computer systems or computing devices. Example communication units 228 include a network interface card (e.g., such as an Ethernet card), an optical transceiver, a radio frequency transceiver, or any other type of device that can send and/or receive information. Other examples of communication units 228 may be devices configured to transmit and receive Ultrawideband®, Bluetooth®, GPS, 3G, 4G, and Wi-Fi®, etc. that may be found in computing devices, such as mobile devices and the like.

As shown in the example of FIG. 2, communication channels 230 may interconnect each of the components as shown for inter-component communications (physically, communicatively, and/or operatively). In some examples, communication channels 230 may include a system bus, a network connection (e.g., to a wireless connection), one or more inter-process communication data structures, or any other components for communicating data between hardware and/or software locally or remotely.

One or more I/O devices 234 of computing system 200 may receive inputs and generate outputs. Examples of inputs are tactile, audio, kinetic, and optical input, to name only a few examples. Input devices of I/O devices 234, in one example, may include a touchscreen, a touchpad, a mouse, a keyboard, a voice responsive system, a video camera, buttons, a control pad, a microphone or any other type of device for detecting input from a human or machine. Output devices of I/O devices 234, may include, a sound card, a video graphics adapter card, a speaker, a display, or any other type of device for generating output to a human or machine.

Icon-action mappings 212, UI module 206, user input module 216, event module 219, UI generator module 208, API module 203, machine learning module 210, speech-to-text module 226, and action module 227, (hereinafter “modules 203-227”) may perform operations described herein using software, hardware, firmware, or a mixture of hardware, software, and firmware residing in and executing on computing system 200 or at one or more other computing devices (e.g., a cloud-based application-not shown). For example, some or all of modules 203-227 may be included in and executable on a local computing device, such as computing device 102 of FIG. 1. As such, the techniques described herein may all be implemented locally on a computing device.

Computing system 200 may execute one or more of modules 203-227, with one or more processors 224 or may execute any or part of one or more of modules 203-227 as or within a virtual machine executing on underlying hardware. One or more of modules 203-227 may be implemented in various ways, for example, as a downloadable or pre-installed application, remotely as a cloud application, or as part of the operating system of computing system 200. Other examples of computing system 200 that implement techniques of this disclosure may include additional components not shown in FIG. 2.

In the example of FIG. 2, one or more processors 224 may implement functionality and/or execute instructions within computing system 200. For example, one or more processors 224 may receive and execute instructions that provide the functionality of UIC 232, communication units 228, one or more storage devices 238 and an operating system to perform one or more operations as described herein. For example, one or more processors 224 may receive and execute instructions that provide the functionality of some or all of modules 203-227 to perform one or more operations and various functions described herein. The one or more processors 224 include a central processing unit (CPU). Examples of CPUs include, but are not limited to, a digital signal processor (DSP), a general-purpose microprocessor, a tensor processing unit (TPU); a neural processing unit (NPU); a neural processing engine; a core of a CPU, VPU, GPU, TPU, NPU or another processing device, an application specific integrated circuit (ASIC), a field programmable logic array (FPGA), or other equivalent integrated or discrete logic circuitry, or other equivalent integrated or discrete logic circuitry.

One or more storage devices 238 within computing system 200 may store information, such as information retrieved from a user computing device, or other data discussed herein, for processing during the operation of computing system 200. In some examples, one or more storage devices of storage devices 238 may be a volatile or temporary memory. Examples of volatile memories include random access memories (RAM), dynamic random-access memories (DRAM), static random-access memories (SRAM), and other forms of volatile memories known in the art. Storage devices 238, in some examples, may also include one or more computer-readable storage media. Storage devices 238 may be configured to store larger amounts of information for longer terms in non-volatile memory than volatile memory. Examples of non-volatile memories include magnetic hard disks, optical discs, floppy discs, flash memories, or forms of electrically programmable memories (EPROM) or electrically erasable and programmable (EEPROM) memories. Storage devices 238 may store program instructions and/or data associated with the modules 203-227 of FIG. 2.

In some examples, user interface generator module 208 may be implemented on a computing device in various ways. For example, user interface generator module 208 may be implemented as a downloadable or pre-installed application or “app.” In another example, user interface generator module 208 may be implemented as part of an operating system of a computing device.

In general, with explicit consent from a user, computing system 200 may retrieve, using API module 203, information (e.g., API response data) associated with a plurality of functions included in one or more applications executing at computing system 200 and/or a computing device in communication with computing system 200 (such as computing device 102 of FIG. 1). In some examples, with explicit user consent, computing system 200 may retrieve data, e.g., user data, and/or context information from the one or more applications, and/or the computing system and/or device itself. For example, the context information may include, but is not limited to, device location data, device information, network information, connectivity information, application usage data, environmental data, user preference data, battery status, sensor data, application permissions, calendar events, notification data, etc.

In general, multimodal input may be received by UI module 206 in response to one or more gestures being detected via I/O devices 234 of computing system 200 and/or I/O devices of a computing device in communication with computing system 200 (such as UID 104 of FIG. 1). That is, UI module 206 may receive inputs detected and/or provided at an input device (e.g., one or more indications of one or more gestures detected at an input device, natural language inputs, image inputs, etc.), and may relay information about the inputs to one or more associated platforms, operating systems, applications, and/or services executing at computing system 200 and/or a computing device in communication with computing system 200 (such as computing device 102 of FIG. 1) to cause computing system 200 and/or the computing device to perform a function. As an example, UI module 206 may output, for display at a display device, a GUI including a plurality of user interface elements. For example, the plurality of user interface elements may include at least a universally accessible button, such as button 105 of FIG. 1. In some examples, responsive to detecting a first gesture (e.g., a tactile event such as a user pressing down with their finger) at a location of the GUI that corresponds to a first user interface element from the plurality of user interface elements (e.g., the universally accessible button), UI module 206 may cause an input device of computing system 200 and/or a computing device in communication with computing system 200 to capture and/or receive input. For example, a user may use a “touch and talk” feature, in which UI module 206 may receive an indication of the first detected tactile event (e.g., a user pressing down on the universally accessible button), and then cause an input device (e.g., a microphone) to capture an indication of a natural language user input. Computing system 200 may then receive the indication of the natural language user input. In some examples, UI module 206 may receive additional indications of additional detected gestures, and then cause one or more other I/O devices to perform a function. For example, UI module 206 may receive an indication of a second detected tactile event detected at a location of the GUI that corresponds to a second user interface element from the plurality of user interface elements (e.g., a user sliding their finger from the universally accessible button to select another user interface element, such as a camera icon). UI module 206 may then output, for display at a display device, a visual indication of receiving an image input (e.g., a window for capturing an image via a device camera). UI module 206 may receive an indication of a third detected tactile event at a location of the GUI that corresponds to the visual indication (e.g., a user lifting their finger off their screen), and then cause an input device (e.g., a camera) to capture an image. Computing system 200 may then receive the indication of the image input.

In some examples, the first gesture and the one or more additional gestures may each be part of a single, continuous gesture. That is, in some examples, UI components 232 of computing system 200 and/or UI components of a computing device in communication with computing system 200 (e.g., UID 104 of FIG. 1) may capture multimodal input (e.g., an indication of a natural language input and an indication of an image input) until a termination event occurs (e.g., a user lifting their finger off their screen or providing some other indication that they have finished providing input), in which UI module 206 may not receive the multimodal input until the termination event occurs. For example, continuing the “touch and talk” example above, the user may perform any number of gestures to cause UI components to capture multimodal input, and responsive to detecting a termination event, the UI components may then send the multimodal input to UI module 206. Although the examples provided herein may describe receiving multimodal input including a natural language user input and an image input, in general, UI module 206 may receive any number of indications of various types of inputs that may be provided by a user (e.g., gestural inputs such as tactile inputs, natural language user inputs, audio inputs, image inputs, file inputs, or text inputs, etc.).

In general, UI module 206 may interpret received inputs, e.g., UI module 206 may determine types of inputs and/or whether a user should repeat or clarify inputs. UI module 206 may also receive information and instructions from one or more associated platforms, operating systems, applications, and/or services (e.g., user interface generator module 208) for generating a file comprising a set of instructions. In general, the set of instructions may provide data for generating one or outputs for display at a display device. In some examples, UI module 206 may act as an intermediary between the one or more associated platforms, operating systems, applications, and/or services and various output devices (e.g., speakers, LED indicators, vibrators, etc.) to produce output (e.g., graphical, audible, tactile, etc.).

UI module 206, in the example of FIG. 2, may include user input module 216 and event module 219. User input module 216 may include software readable instructions for determining indications of user inputs. User input module 216 may determine indications of user inputs based on inputs received by I/O devices 234. For instance, user input module 216 may process data of a tactile input received by I/O devices 234 to determine an indication of the tactile input provided at a location of a GUI (e.g., pixel coordinates associated with the GUI). User input module 216 may generate a touch event based on the determined location of the GUI where the tactile input was provided. User input module 216 may perform hit testing to identify which graphical component (e.g., user interface element, object, view, etc.) corresponds to the tactile input received by I/O devices 234. User input module 216 may dispatch the touch event and identified graphical component to event module 219. In some examples, user input module 216 may determine a location of a GUI where a motion input was provided (e.g., eye movement, spatial motion detection, etc.). User input module 216 may dispatch a motion event associated with a location of a GUI.

Event module 219 may include software readable instructions for handling events generated by user input module 216. For example, event module 219 may include a subscriber configured to register multiple listeners to various events generated by user input module 216. Event module 219 may implement a listener configured to retrieve data for a GUI associated with an event generated by user input module 216. For example, user input module 216 may generate an event based on an indication of a user input provided at a location (e.g., location 120A of FIG. 1) of a zero state GUI (e.g., GUI 114A of FIG. 1) associated with an invocation point (e.g., button 105, another virtual home button, a navigation handle, a search bar, or other GUI element). Event module 219 may implement a listener configured to retrieve data for a switching state GUI (e.g., GUI 114B of FIG. 1) responsive to receiving the event generated by user input module 216. Event module 219 may output the data for the switching state GUI to I/O devices 234 for display.

In another example, user input module 216 may generate an event based on an indication of a user input provided at a location (e.g., location 120B of FIG. 1) of a switching state GUI (e.g., GUI 114B of FIG. 1) associated with an UI element from a plurality of UI elements (e.g., UI element 107 of FIG. 1) displayed in the switching state GUI. Event module 219 may implement a listener configured to retrieve data for an input state GUI (e.g., GUI 114C of FIG. 1) responsive to receiving the event generated by user input module 216. Event module 219 may output the data for input state GUI to I/O device 234 for display.

In another example, user input module 216 may generate an event based on a user input terminating at a location (e.g., location 120C of FIG. 1) of an input state GUI (e.g., GUI 114C of FIG. 1) associated with a selected UI element (e.g., UI element 107 of FIG. 1) displayed in the input GUI. Event module 219 may implement a listener configured to retrieve data for an action mapped to the icon responsive to receiving the event generated by user input module 216. Event module 219 may initiate the action (e.g., send data to a computing device to cause the computing device to perform the action) based on the retrieved data for the action. Event module 219 may retrieve data for the action from icon-action mappings 212. In some examples, event module 219 may forward events associated with a user input terminating at a location of an input state GUI to action module 227.

Action module 227 may include software readable instructions for initiating actions based on events received from event module 219. For example, action module 227 may be configured to initiate an action based on an event associated with a user input terminating at a location of an input state GUI generated by user input module 216. Action module 227 may determine an action to initiate based on an icon associated with the event and icon-action mappings 212. For example, user input module 216 may generate an event based on a user input terminating at a location associated with an icon included in an input state GUI. User input module 216 may generate the event to include an indication of the icon. User input module 216 may send the event to action module 227. Action module 227 may query icon-action mappings 212 to retrieve data for initiating an action associated with the icon.

Icon-action mappings 212 may include configuration information specifying correlations of multimodal input actions to icons within a switching state GUI (e.g., GUI 114B of FIG. 1). In some examples, icon-action mappings 212 may include an index table data structure for retrieving data for actions initiated by event module 219 and/or action module 227. For example, icon-action mappings 212 may include key-value pairs where a key indicates an icon displayed in a switching state GUI, and a value includes a reference to a location of storage devices 238 where data for a respective action is stored. In general, icon-action mappings 212 may include a data structure that maps data for initiating actions to respective UI elements (e.g., UI element 107 of FIG. 1). In some examples, icon-action mappings 212 may include a predefined mapping of actions to icons. In some instances, icon-action mappings 212 may be configurable by a user. For example, computing system 200 may output a GUI, via I/O devices 234, prompting a user to select icons to be included in a switching state GUI and select actions to be mapped to the icons. Computing system 200 may receive, via I/O devices 234, user inputs of icon-action mappings. Computing system 200 may store the user inputs of icon-action mappings as icon-action mappings 212.

In the example of FIG. 2, UI generator module 208 may receive, from UI module 206, indications of multimodal input. For example, the multimodal input may include a natural language user input, which may be an audio or text input from a user. In examples where the user input is an audio input (e.g., comprising spoken language), speech-to-text module 226 may convert the input into a computer-readable format. Speech-to-text module 226 may implement an Automatic Speech Recognition (ASR) system to convert an audio input (e.g., a digital audio signal) into written text. In some examples, speech-to-text module 226 may preprocess the audio input to enhance quality and remove noise by normalizing the audio volume and filtering out any background noise. Speech-to-text module 226 may then transform the audio input into a more suitable format and extract features such as Mel-frequency cepstral coefficients (MFCCs), which capture information about the frequency content of the audio signal over short time intervals. In some examples, speech-to-text module 226 may perform acoustic modeling (e.g., with Hidden Markov Models (HMMs)), which may involve training a statistical model that maps the extracted audio features to phonemes. The acoustic model may learn to associate specific audio features with phonemes while taking into account the variations in pronunciation, accents, and speaking styles. In some examples, speech-to-text module 226 may further implement language modeling (e.g., deep learning techniques, such as recurrent neural networks (RNNs) and transformers) to capture and predict a sequence of words or phrases while considering the context in which the words are spoken (e.g., speech-to-text module 226 may use context information received by UI module 206). Speech-to-text module 226 may further use the trained acoustic and language models to decode the audio input and generate a transcription or sequence of words that best match the observed audio features. Speech-to-text module 226 may further implement post-processing techniques (e.g., grammar checks, contextual analysis, spell correction, etc.) to refine the transcription and improve readability and accuracy. Speech-to-text module 226 may then output the transcribed text that represents the audio input to machine learning module 210 for further processing and analysis.

Instructions storage 229 is a storage repository that may store, with explicit user consent, information retrieved by API module 203 and/or other data for use by computing system 200 (e.g., output from speech-to-text module 226). In general, the information retrieved by API module 203 may include API response data. For example, the information may be retrieved from one or more applications, and may be associated with the one or more functions included in the one or more applications, e.g., the statically defined capabilities or features of an application. For example, an application may include an API that enables external applications or modules to interact with and use the data stored by the application. As such, API module 203 may retrieve data associated with the functionality of the one or more applications, e.g., an API response. As an example, a banking application may include functionality for displaying a current balance of a user's bank account. API module 203 may use the banking application API to retrieve the information associated with the functionality, which may include, for example, a value for the current balance of the user's bank account, but may not include all of the predefined or statically defined functionality or logic for determining and displaying the value for the current balance of the user's bank account. In some examples, the information may additionally or alternatively include system data, environmental data, time data (e.g., when data is received by an application, timestamped data, etc.), event data, notification data (e.g., notifications generated by an application), security data, application and/or device metadata, etc. Information may be stored in instructions storage 229 for use by other modules of user interface generator module 208, such as machine learning module 210. In some examples, instructions storage 229 may operate, at least in part, as a cache for instructions retrieved from a computing device (e.g., using one or more communication units 228) or other computing devices. In general, instructions storage 229 may be configured as a database, flat file, table, or other data structure stored within storage device 238. In some examples, instructions storage 229 is shared between various modules executing at computing system 200 (e.g., between one or more of modules 203-227 or other modules not shown in FIG. 2). In other examples, a different data repository is configured for a module executing at computing system 200 that requires a data repository. Each data repository may be configured and managed by different modules and may store data in a different manner. In some examples, computing system 200 may receive and store information, such as the context information, from a computing device over a specified period of time.

In general, machine learning module 210 may be configured to interpret various types of input received by UI module 206 and information stored in instructions storage 229, such as to identify one or more tasks. In some examples, machine learning module 210 may be configured to infer any indication of a natural language user input. In other words, machine learning module 210 may infer capabilities from user intents. In some examples, machine learning module 210 may search capabilities. In some examples, machine learning module 210 may convert the audio or text input received by UI module 206, the transcribed text output from speech-to-text module 226, and/or any information retrieved by API module 203 into structured text. For example, machine learning module 210 may convert any input or information to an eXtensible Markup Language (XML), or other structured text types, such as, but not limited to, HTML, JSON, CSV, INI Files, etc. In this way, the information and input received by user interface generator module 208 can be provided to ML module 210 in a standardized format. Furthermore, in some examples, machine learning module 210 may determine the type of information to include in the structured text representation. More specifically, machine learning module 210 may analyze various application functionality, capabilities, and attributes included in information retrieved and/or stored by computing system 200, such as content descriptions, roles, states, actions, and/or other relevant properties of user interface elements, the contextual information associated with the user input, input received by UI module 206, and/or the transcribed text output from speech-to-text module 226. In some examples, input and/or information received by computing system 200 may be preprocessed. Preprocessing techniques may include extracting one or more additional features from raw data. For example, feature extraction techniques may be applied to the user input or retrieved instructions to generate one or more new, additional features.

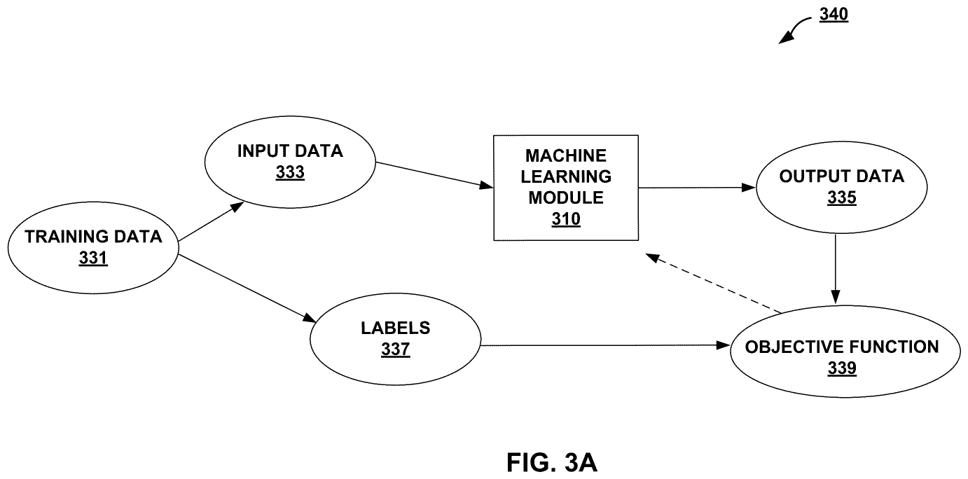

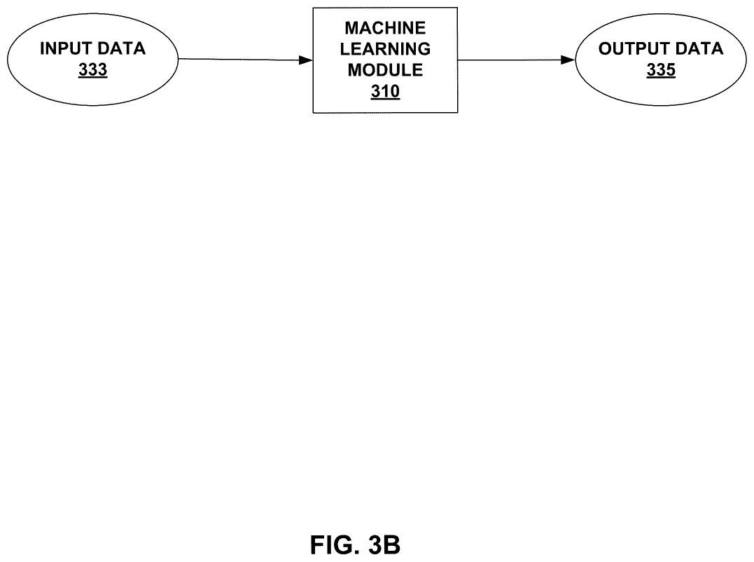

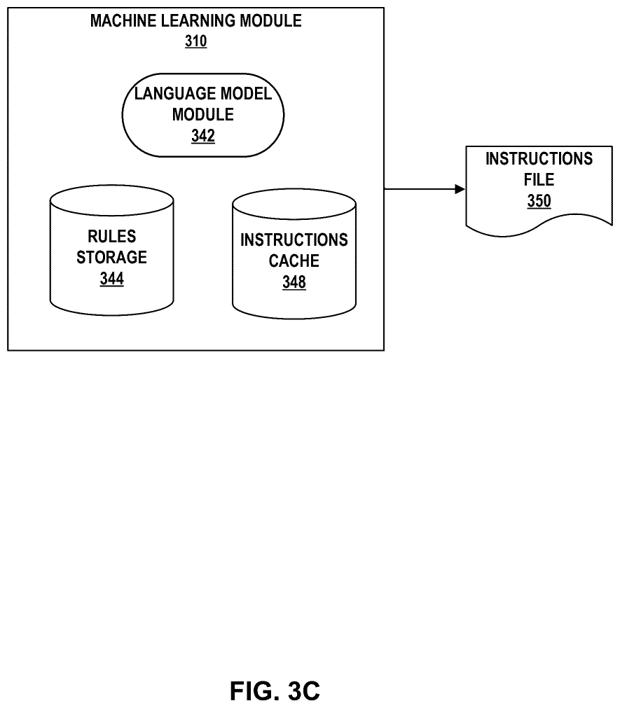

In general, the multimodal input received by computing system 200 may include natural language user input that indicates a command for performing a task. In some examples, the task may be associated with a plurality of functions included in a plurality of applications. In general, machine learning module 210 may employ a large language model (LLM) that can interpret received multimodal input and information stored in instructions storage 229 (e.g., application data) to identify one or more tasks. In some examples, machine learning module 210 may implement other machine-learned models that may be used in place of or in conjunction with an LLM model, such as those described with respect to FIGS. 3A, 3B, and 3C. Machine learning module 210 may employ an LLM that can infer indications of natural language input. Machine learning module 210 may, for example, parse through the natural language user input to determine a user's intent and identify one or more tasks. In some examples, machine learning module 210 may employ one more models that can receive and process multimodal input. That is, in some examples, machine learning module 210 may employ multimodal Transformer models that can process natural language inputs and image inputs simultaneously. In some examples, machine learning module 210 may analyze portions of information to interpret and understand other portions of information. Machine learning module 210 may analyze information (e.g., application data) to interpret and understand the functionality included in computing system 200 and/or included in a device in communication with computing system 200, so as to determine one or more applications including functions for completing an identified task. For example, machine learning module 210 may identify, based on the “Unlock bike” command and an image of a code for unlocking the bike, a task of electronically unlocking a bike. Then, based on information stored in instructions storage 229, machine learning module 210 may determine an associated bike rental application installed at computing system 200 and/or a user device in communication with computing system 200, in which the bike rental application includes functionality for receiving the code and electronically unlocking a bike based on the code. That is, in general, machine learning module 210 may identify at least one application including at least one function for performing a user's task. Computing system 200 may then generate at least one output associated with at least one application.

In some examples, computing system 200 may execute or send instructions to execute an application to perform the task based on the multimodal input. In some examples, UI generator module 208 may employ API module 203 to send requests to the bike rental application's API, such as to provide input and receive output, e.g., information associated with the bike rental application's functionality for unlocking the bike. In some examples, UI generator module 208 may generate data for one or more graphical components associated with the bike rental application, e.g., a GUI indicating that the bike was successfully unlocked, which may be sent to a display device for display to the user.

In some examples, UI generator module 208 may receive an indication of a search query (e.g., in the form of natural language text or audio), in which machine learning module 210 may determine multiple applications that can answer the search query.

In some examples, the output generated by computing system 200 may include GUIs (e.g., widgets, “result cards”) for the multiple associated applications, which may be presented within a single frame of the user's screen, and may be positioned based on a respective level of relevance. That is, machine learning module 210 may assign each associated application a respective level of relevance, e.g., based on information stored in instructions storage 229 (such as historical user data, application data, context information, etc.), and a display of the outputs generated by computing system 200, e.g., the GUIs (e.g., widgets) for the multiple associated applications, may be based on the respective level of relevance. Another example of output may include suggested search queries (e.g., associated application GUIs or widgets with text entry fields that are pre-populated with the suggested search query).

As such, in general, machine learning module 210 may evaluate and rank applications and/or service responses based on user device information, user interaction history, user profile signals, etc. to ensure the most helpful order of displayed outputs. In some examples, machine learning module 210 may summarize all of the application and/or service results and display an actionable summary UI that may be generated based on user intent. Users may easily compare and pivot between and/or engage with results from different applications and/or services by interacting with the result cards, which may launch a corresponding application. In general, computing system 200 may include an “allow” list for users to customize which application and services have access to their intents. In some examples, computing system 200 may also proactively suggest new applications and/or services that may offer cheaper, better, or more relevant options to fulfill a user's intent. In some examples, computing system 200 may offer to string multiple user intents together. In some examples, application and/or service providers may develop integrations that are exposed to computing system 200, and/or computing system 200 may ask (e.g., send a prompt to) the user to teach it how to access the content or action necessary to perform a task in the future, e.g., using drive-by-wire techniques. In general. application and/or service content and actions may be surfaced as responses to user queries and/or as part of operating system surfaces.

Thus, in general, users may provide multimodal input indicative of a task (e.g., answering a query, electronically unlocking a bike, etc.), and computing system 200 may dynamically generate output associated with one or more applications that are relevant for performing the task. In this way, the techniques described in this disclosure may help users perform tasks more efficiently, as users may no longer be required to navigate through multiple user interfaces of multiple applications to capture various input data, and instead may complete their tasks through a few simple UI interactions.

FIG. 3A is a conceptual diagram illustrating an example training process for a machine learning module, in accordance with one or more techniques of this disclosure. In some examples, computing device 102 of FIG. 1 may store and implement machine learning module 310 locally (i.e., on-device). Thus, in some examples, machine learning module 310 can be stored at and/or implemented locally by an embedded device or a user computing device such as a mobile device. Output data obtained through local implementation of machine learning module 310 at the embedded device or the user computing device can be used to improve performance of the embedded device or the user computing device (e.g., an application implemented by the embedded device or the user computing device). Machine learning module 310 described herein can be trained at a training computing system, and then provided for storage and/or implementation at one or more computing devices, such as computing device 102 of FIG. 1. In some examples, training process 340 executes locally at computing system 100 of FIG. 1. However, in some examples, training process 340 can be included in or separate from any computing system that implements machine learning module 310.

In general, machine learning module 310 may be or include one or more inference models, i.e., one or more trained machine learning models that can be used to make predictions based on new, unseen data. Machine learning module 310 may “infer” conclusions or outputs, which may be predictions, classifications, recommendations, or other types of decision-making. Machine learning module 310 may be trained according to one or more of various different training types or techniques. For example, in some examples, machine learning module 310 may be trained by training process 340 of FIG. 3A.

As further shown in the example of FIG. 3A, in some examples, machine learning module 310 may be trained on training data 331 that may include input data 333 that has labels 337. The training process shown in FIG. 3A is one example training process; other training processes may be used as well. In general, during training process 340, machine learning module 310 may learn patterns from training data 331, and training process 340 may optimize parameters for machine learning module 310 to minimize prediction errors.

Training data 331 can include, upon user permission for use of such data for training, anonymized usage logs of sharing flows, e.g., content items that were shared together, bundled content pieces already identified as belonging together, e.g., from entities in a knowledge graph, etc. In some examples, training data 331 can include examples of input data 333 that have been assigned labels 337 that correspond to output data 335.

In some examples, machine learning module 310 can be trained by optimizing an objective function, such as objective function 339. For example, in some examples, objective function 339 may be or include a loss function that compares (e.g., determines a difference between) output data generated by the model from the training data and labels (e.g., ground-truth labels) associated with the training data. For example, the loss function can evaluate a sum or mean of squared differences between output data 335 and the labels. In some examples, objective function 339 may be or include a cost function that describes a cost of a certain outcome or output data. Other examples of objective function 339 can include margin-based techniques such as, for example, triplet loss or maximum-margin training.

One or more of various optimization techniques can be performed to optimize objective function 339. For example, the optimization technique(s) can minimize or maximize objective function 339. Example optimization techniques include Hessian-based techniques and gradient-based techniques, such as, for example, coordinate descent; gradient descent (e.g., stochastic gradient descent); subgradient methods; etc. Other optimization techniques include black box optimization techniques and heuristics.

In some examples, backward propagation of errors can be used in conjunction with an optimization technique (e.g., gradient based techniques) to train machine learning module 310 (e.g., when a machine-learned model is a multi-layer model such as an artificial neural network). For example, an iterative cycle of propagation and model parameter (e.g., weights) update can be performed to train machine learning module 310. Example backpropagation techniques include truncated backpropagation through time, Levenberg-Marquardt backpropagation, etc.

In some examples, machine learning module 310 described herein can be trained using unsupervised learning techniques. Unsupervised learning can include inferring a function to describe hidden structure from unlabeled data. For example, a classification or categorization may not be included in the data. Unsupervised learning techniques can be used to produce machine-learned models capable of performing clustering, anomaly detection, learning latent variable models, or other tasks.

Machine learning module 310 can be trained using semi-supervised techniques which combine aspects of supervised learning and unsupervised learning. Machine learning module 310 can be trained or otherwise generated through evolutionary techniques or genetic algorithms. In some examples, machine learning module 310 described herein can be trained using reinforcement learning. In reinforcement learning, an agent (e.g., model) can take actions in an environment and learn to maximize rewards and/or minimize penalties that result from such actions. Reinforcement learning can differ from the supervised learning problem in that correct input/output pairs are not presented, nor sub-optimal actions explicitly corrected.

In some examples, one or more generalization techniques can be performed during training to improve the generalization of machine learning module 310. Generalization techniques can help reduce overfitting of machine learning module 310 to the training data. Example generalization techniques include dropout techniques; weight decay techniques; batch normalization; early stopping; subset selection; stepwise selection; etc.

In some examples, machine learning module 310 described herein can include or otherwise be impacted by a number of hyperparameters, such as, for example, learning rate, number of layers, number of nodes in each layer, number of leaves in a tree, number of clusters; etc. Hyperparameters can affect model performance. Hyperparameters can be hand selected or can be automatically selected through application of techniques such as, for example, grid search; black box optimization techniques (e.g., Bayesian optimization, random search, etc.); gradient-based optimization; etc. Example techniques and/or tools for performing automatic hyperparameter optimization include Hyperopt; Auto-WEKA; Spearmint; Metric Optimization Engine (MOE); etc.

In some examples, various techniques can be used to optimize and/or adapt the learning rate when the model is trained. Example techniques and/or tools for performing learning rate optimization or adaptation include Adagrad; Adaptive Moment Estimation (ADAM); Adadelta; RMSprop; etc.

In some examples, transfer learning techniques can be used to provide an initial model from which to begin training of machine learning module 310 described herein. In some examples, transfer learning involves reusing a model and its model parameters obtained while solving one problem and applying it to a different but related problem. Models trained on very large data sets may be retrained or fine-tuned on additional data. Often, all model designs and their parameters on a source model are copied except output layer(s). The output layers(s) are often called the head, and other layers are often called the base. The source parameters may be considered to contain the knowledge learned from the source dataset and this knowledge may also be applicable to a target dataset. Fine-tuning may include updating the head parameters with the body parameters being fixed or updated in a later step.

In some examples, machine learning module 310 may be trained in an offline fashion or an online fashion. In offline training (also known as batch learning), machine learning module 310 is trained on the entirety of a static set of training data. In online learning, machine learning module 310 is continuously trained (or re-trained) as new training data becomes available (e.g., while the model is used to perform inference).

In some examples, training process 340 may involve centralized training of machine learning module 310 (e.g., based on a centrally stored dataset). In other implementations, decentralized training techniques such as distributed training, federated learning, or the like can be used to train, update, or personalize machine learning module 310.

Machine learning module 310 described herein can be trained according to one or more of various different training types or techniques. For example, in some examples, machine learning module 310 can be trained by training process 340 using supervised learning, in which machine learning module 310 is trained on a training dataset that includes instances or examples that have labels. The labels can be manually applied by experts, generated through crowd-sourcing, or provided by other techniques (e.g., by physics-based or complex mathematical models). In some examples, if the user has provided consent, the training examples can be provided by the user computing device. In some examples, this process can be referred to as personalizing the model.

In some examples, machine learning module 310 includes a language model that may be trained (e.g., pre-trained, fine-tuned, etc.) by training process 340. For example, training process 340 may pre-train a language model on a large and diverse corpus of text. As such, in some examples, training data 331 may include a dataset that covers a wide range of topics and domains to ensure machine learning module 310 learns diverse linguistic patterns and contextual relationships. Training process 340 may train a language model to optimize objective function 339. Objective function 339 may be or include a loss function, such as cross-entropy loss, that compares (e.g., determines a difference between) output data generated by the model from training data 331 and labels 337 (e.g., ground-truth labels) associated with training data 331. For example, objective function 339 for a language model may be to correctly predict the next word in a sequence of words or correctly fill in missing words as much as possible.

In some examples, training process 340 may use techniques such low-rank adaptation (LoRA) to train or fine-tune language models (LLMs) implemented by machine learning module 310. In general, LoRA may reduce the number of trainable parameters by freezing pre-trained weights of an LLM and injecting small, trainable low-rank matrices that adapt the model for specific tasks. LoRa may be useful when a model needs to be adapted to multiple tasks with limited task-specific data. That is, training process 340 may use LoRA for task-specific fine-tuning. In some examples, training process 340 may use techniques such as retrieval-augmented generation (RAG), which is a hybrid framework that combines information retrieval with text generation. RAG may be used to fine-tune a generative model implemented by machine learning module 310 by retrieving relevant information from an external database or dataset (e.g., a large and diverse corpus of text) and using that information to generate output that is more accurate and informative. RAG may be useful for generating more factually accurate and contextually relevant summaries and responses to questions.

In some examples, training process 340 may continuously or periodically train a language model included in machine learning module 310. In some examples, training process 340 may fine-tune a language model by using feedback in the training process. For example, UI component 232 of FIG. 2 may receive a user input via a computing device that selects feedback (e.g., thumbs up, thumbs down, etc.) relating to the generated application functionality and associated GUIs that are presented to the user on the computing device. In some examples, the feedback may indicate whether the generated application functionality and associated GUIs are accurate or inaccurate, correct or incorrect, high quality or low quality, etc. UI module 206 may receive this feedback and may send it to user interface generator module 208. User interface generator module 208 may transmit the feedback to machine learning module 310 (specifically to training process 340), in which training process 340 uses the feedback for training. For example, training process 340 may convert the feedback into labeled data for supervised training. Additionally or alternatively, training process 340 may fine-tune a language model by monitoring the relationship between the performance of the language model and user feedback, and iterate the fine-tuning process as necessary (e.g., to receive more positive user feedback and less negative user feedback). In this way, the techniques of this disclosure may establish a feedback loop that continuously improves the quality of output data 335 (e.g., an instructions file) of a language model.

FIG. 3B is a conceptual diagram illustrating an example trained machine learning module, in accordance with one or more techniques of this disclosure. In some examples, computing device 102 of FIG. 1 may store and implement machine learning module 310 locally (i.e., on-device). Thus, in some examples, machine learning module 310 can be stored at and/or implemented locally by an embedded device or a user computing device such as a mobile device. Output data obtained through local implementation of machine learning module 310 at the embedded device or the user computing device can be used to improve performance of the embedded device or the user computing device (e.g., an application implemented by the embedded device or the user computing device). Machine learning module 310 of FIG. 3B may be trained at a computing system, such as computing system 100 of FIG. 1, and then provided for storage and/or implementation at one or more computing devices, such as computing device 102 of FIG. 1. In some examples, machine learning module 310 executes locally at computing system 100 of FIG. 1. In some examples, computing system 100 may perform machine learning as a service.

As illustrated in FIG. 3B, in some examples, machine learning module 310 is trained (e.g., via training process 340 of FIG. 3A) to receive input data 333, which may be of one or more types and, in response, provide output data 335, which may be of one or more types. Thus, FIG. 3B illustrates machine learning module 310 performing inference, in which machine learning module 310 may use learned patterns to make predictions or decisions on new data, e.g., input data 333. Machine learning module 310 may include one or more machine-learned models trained by training process 340 of FIG. 3A.

Input data 333 may include one or more features that are associated with an instance or an example. In some examples, the one or more features associated with the instance or example can be organized into a feature vector. In some examples, output data 335 can include one or more predictions. Predictions can also be referred to as inferences. Thus, given features associated with a particular instance, machine learning module 310 can output a prediction for such instance based on the features.

Machine learning module 310 can be or include one or more of various different types of machine-learned models. In particular, in some examples, machine learning module 310 may perform NLP tasks. Machine learning module 310 may summarize, translate, or organize input data 333. Machine learning module 310 may use recurrent neural networks (RNNs) and/or transformer models (self-attention models). Example models may include, but are not limited to, GPT-3, BERT, Gemini (e.g., Gemini Ultra, Gemini Pro, Gemini Flash, Gemini Nano), Android AICore, and T5. In some examples, machine learning module 310 may perform classification, summarization, name generation, regression, clustering, anomaly detection, recommendation generation, and/or other tasks.

In some examples, machine learning module 310 can perform various types of classification based on input data 333. For example, machine learning module 310 can perform binary classification or multiclass classification. In binary classification, output data 335 can include a classification of input data 333 into one of two different classes. In multiclass classification, output data 335 can include a classification of input data 333 into one (or more) of more than two classes. The classifications can be single label or multi-label. Machine learning module 310 may perform discrete categorical classification in which input data 333 is simply classified into one or more classes or categories.

In some examples, machine learning module 310 can perform classification in which machine learning module 310 provides, for each of one or more classes, a numerical value descriptive of a degree to which it is believed that input data 333 should be classified into the corresponding class. In some instances, the numerical values provided by machine learning module 310 can be referred to as “confidence scores” that are indicative of a respective confidence associated with classification of the input into the respective class. In some examples, the confidence scores can be compared to one or more thresholds to render a discrete categorical prediction. In some examples, only a certain number of classes (e.g., one) with the relatively largest confidence scores can be selected to render a discrete categorical prediction.

Machine learning module 310 may output a probabilistic classification. For example, machine learning module 310 may predict, given a sample input, a probability distribution over a set of classes. Thus, rather than outputting only the most likely class to which the sample input should belong, machine learning module 310 can output, for each class, a probability that the sample input belongs to such class. In some examples, the probability distribution over all possible classes can sum to one. In some examples, a Softmax function, or other type of function or layer can be used to squash a set of real values respectively associated with the possible classes to a set of real values in the range (0, 1) that sum to one.

In some examples, the probabilities provided by the probability distribution can be compared to one or more thresholds to render a discrete categorical prediction. In some examples, only a certain number of classes (e.g., one) with the relatively largest predicted probability can be selected to render a discrete categorical prediction.

In cases in which machine learning module 310 performs classification, machine learning module 310 may be trained using supervised learning techniques. For example, machine learning module 310 may be trained on a training dataset that includes training examples labeled as belonging (or not belonging) to one or more classes.

In some examples, machine learning module 310 can perform regression to provide output data in the form of a continuous numeric value. The continuous numeric value can correspond to any number of different metrics or numeric representations, including, for example, currency values, scores, or other numeric representations. As examples, machine learning module 310 can perform linear regression, polynomial regression, or nonlinear regression. As examples, machine learning module 310 can perform simple regression or multiple regression. As described above, in some examples, a Softmax function or other function or layer can be used to squash a set of real values respectively associated with two or more possible classes to a set of real values in the range (0, 1) that sum to one.

Machine learning module 310 may perform various types of clustering. For example, machine learning module 310 can identify one or more previously-defined clusters to which input data 333 most likely corresponds. Machine learning module 310 may identify one or more clusters within input data 333. That is, in instances in which input data 333 includes multiple objects, documents, or other entities, machine learning module 310 can sort the multiple entities included in input data 333 into a number of clusters. In some examples in which machine learning module 310 performs clustering, machine learning module 310 can be trained using unsupervised learning techniques.

Machine learning module 310 may perform anomaly detection or outlier detection. For example, machine learning module 310 can identify input data that does not conform to an expected pattern or other characteristic (e.g., as previously observed from previous input data). As examples, the anomaly detection can be used for fraud detection or system failure detection.

In some examples, machine learning module 310 can provide output data in the form of one or more recommendations. For example, machine learning module 310 can be included in a recommendation system or engine. As an example, given input data that describes previous outcomes for certain entities (e.g., a score, ranking, or rating indicative of an amount of success or enjoyment), machine learning module 310 can output a suggestion or recommendation of one or more additional entities that, based on the previous outcomes, are expected to have a desired outcome (e.g., elicit a score, ranking, or rating indicative of success or enjoyment). As one example, given input data descriptive of a context of a computing device, such as computing device 102 of FIG. 1, a recommendation system can output a suggestion or recommendation of an application that the user might enjoy or wish to download to computing device 102.

Machine learning module 310 may, in some cases, act as an agent within an environment. For example, machine learning module 310 can be trained using reinforcement learning, which will be discussed in further detail below.

In some examples, machine learning module 310 can be a parametric model while, in other implementations, machine learning module 310 can be a non-parametric model. In some examples, machine learning module 310 can be a linear model while, in other implementations, machine learning module 310 can be a non-linear model.

As described above, machine learning module 310 can be or include one or more of various different types of machine-learned models. Examples of such different types of machine-learned models are provided below for illustration. One or more of the example models described below can be used (e.g., combined) to provide output data 335 in response to input data 333. Additional models beyond the example models provided below can be used as well.

In some examples, machine learning module 310 can be or include one or more classifier models such as, for example, linear classification models; quadratic classification models; etc. Machine learning module 310 may be or include one or more regression models such as, for example, simple linear regression models; multiple linear regression models; logistic regression models; stepwise regression models; multivariate adaptive regression splines; locally estimated scatterplot smoothing models; etc.

In some examples, machine learning module 310 can be or include one or more decision tree-based models such as, for example, classification and/or regression trees; iterative dichotomiser 3 decision trees; C4.5 decision trees; chi-squared automatic interaction detection decision trees; decision stumps; conditional decision trees; etc.

Machine learning module 310 may be or include one or more kernel machines. In some examples, machine learning module 310 can be or include one or more support vector machines. Machine learning module 310 may be or include one or more instance-based learning models such as, for example, learning vector quantization models; self-organizing map models; locally weighted learning models; etc. In some examples, machine learning module 310 can be or include one or more nearest neighbor models such as, for example, k-nearest neighbor classifications models; k-nearest neighbors regression models; etc. Machine learning module 310 can be or include one or more Bayesian models such as, for example, naïve Bayes models; Gaussian naïve Bayes models; multinomial naïve Bayes models; averaged one-dependence estimators; Bayesian networks; Bayesian belief networks; hidden Markov models; etc.

In some examples, machine learning module 310 can be or include one or more artificial neural networks (also referred to simply as neural networks). A neural network can include a group of connected nodes, which also can be referred to as neurons or perceptrons. A neural network can be organized into one or more layers. Neural networks that include multiple layers can be referred to as “deep” networks. A deep network can include an input layer, an output layer, and one or more hidden layers positioned between the input layer and the output layer. The nodes of the neural network can be connected or non-fully connected.

Machine learning module 310 can be or include one or more feed forward neural networks. In feed forward networks, the connections between nodes do not form a cycle. For example, each connection can connect a node from an earlier layer to a node from a later layer.

In some instances, machine learning module 310 can be or include one or more recurrent neural networks. In some instances, at least some of the nodes of a recurrent neural network can form a cycle. Recurrent neural networks can be especially useful for processing input data that is sequential in nature. In particular, in some instances, a recurrent neural network can pass or retain information from a previous portion of input data 333 sequence to a subsequent portion of input data 333 sequence through the use of recurrent or directed cyclical node connections.

In some examples, sequential input data can include time-series data (e.g., sensor data versus time or imagery captured at different times). For example, a recurrent neural network can analyze sensor data versus time to detect or predict a swipe direction, to perform handwriting recognition, etc. Sequential input data may include words in a sentence (e.g., for natural language processing, speech detection or processing, etc.); notes in a musical composition; sequential actions taken by a user (e.g., to detect or predict sequential application usage); sequential object states; etc.

Example recurrent neural networks include long short-term (LSTM) recurrent neural networks; gated recurrent units; bi-direction recurrent neural networks; continuous time recurrent neural networks; neural history compressors; echo state networks; Elman networks; Jordan networks; recursive neural networks; Hopfield networks; fully recurrent networks; sequence-to-sequence configurations; etc.

In some examples, machine learning module 310 can be or include one or more convolutional neural networks. In some instances, a convolutional neural network can include one or more convolutional layers that perform convolutions over input data using learned filters.

Filters can also be referred to as kernels. Convolutional neural networks can be especially useful for vision problems such as when input data 333 includes imagery such as still images or video. However, convolutional neural networks can also be applied for natural language processing.

In some examples, machine learning module 310 can be or include one or more generative networks such as, for example, generative adversarial networks. Generative networks can be used to generate new data such as new images or other content.

Machine learning module 310 may be or include an autoencoder. In some instances, the aim of an autoencoder is to learn a representation (e.g., a lower-dimensional encoding) for a set of data, typically for the purpose of dimensionality reduction. For example, in some instances, an autoencoder can seek to encode input data 333 and then provide output data that reconstructs input data 333 from the encoding. Recently, the autoencoder concept has become more widely used for learning generative models of data. In some instances, the autoencoder can include additional losses beyond reconstructing input data 333.

Machine learning module 310 may be or include one or more other forms of artificial neural networks such as, for example, deep Boltzmann machines; deep belief networks; stacked autoencoders; etc. Any of the neural networks described herein can be combined (e.g., stacked) to form more complex networks.

One or more neural networks can be used to provide an embedding based on input data 333. For example, the embedding can be a representation of knowledge abstracted from input data 333 into one or more learned dimensions. In some instances, embeddings can be a useful source for identifying related entities. In some instances, embeddings can be extracted from the output of the network, while in other instances embeddings can be extracted from any hidden node or layer of the network (e.g., a close to final but not final layer of the network). Embeddings can be useful for performing auto suggest next video, product suggestion, entity or object recognition, etc. In some instances, embeddings can be useful inputs for downstream models. For example, embeddings can be useful to generalize input data (e.g., search queries) for a downstream model or processing system.

Machine learning module 310 may include one or more clustering models such as, for example, k-means clustering models; k-medians clustering models; expectation maximization models; hierarchical clustering models; etc.

In some examples, machine learning module 310 can perform one or more dimensionality reduction techniques such as, for example, principal component analysis; kernel principal component analysis; graph-based kernel principal component analysis; principal component regression; partial least squares regression; Sammon mapping; multidimensional scaling; projection pursuit; linear discriminant analysis; mixture discriminant analysis; quadratic discriminant analysis; generalized discriminant analysis; flexible discriminant analysis; autoencoding; etc.

In some examples, machine learning module 310 can perform or be subjected to one or more reinforcement learning techniques such as Markov decision processes; dynamic programming; Q functions or Q-learning; value function approaches; deep Q-networks; differentiable neural computers; asynchronous advantage actor-critics; deterministic policy gradient; etc.

In some examples, machine learning module 310 can be an autoregressive model. In some instances, an autoregressive model can specify that output data 335 depends linearly on its own previous values and on a stochastic term. In some instances, an autoregressive model can take the form of a stochastic difference equation. One example autoregressive model is WaveNet, which is a generative model for raw audio.

In some examples, machine learning module 310 can include or form part of a multiple model ensemble. As one example, bootstrap aggregating can be performed, which can also be referred to as “bagging.” In bootstrap aggregating, a training dataset is split into a number of subsets (e.g., through random sampling with replacement) and a plurality of models are respectively trained on the number of subsets. At inference time, respective outputs of the plurality of models can be combined (e.g., through averaging, voting, or other techniques) and used as the output of the ensemble.

One example ensemble is a random forest, which can also be referred to as a random decision forest. Random forests are an ensemble learning method for classification, regression, and other tasks. Random forests are generated by producing a plurality of decision trees at training time. In some instances, at inference time, the class that is the mode of the classes (classification) or the mean prediction (regression) of the individual trees can be used as the output of the forest. Random decision forests can correct for decision trees'tendency to overfit their training set.

Another example ensemble technique is stacking, which can, in some instances, be referred to as stacked generalization. Stacking includes training a combiner model to blend or otherwise combine the predictions of several other machine-learned models. Thus, a plurality of machine-learned models (e.g., of same or different type) can be trained based on training data. In addition, a combiner model can be trained to take the predictions from the other machine-learned models as inputs and, in response, produce a final inference or prediction. In some instances, a single-layer logistic regression model can be used as the combiner model.

Another example of an ensemble technique is boosting. Boosting can include incrementally building an ensemble by iteratively training weak models and then adding to a final strong model. For example, in some instances, each new model can be trained to emphasize the training examples that previous models misinterpreted (e.g., misclassified). For example, a weight associated with each of such misinterpreted examples can be increased. One common implementation of boosting is AdaBoost, which can also be referred to as Adaptive Boosting. Other example boosting techniques include LPBoost; TotalBoost; BrownBoost; xgboost; MadaBoost, LogitBoost, gradient boosting; etc. Furthermore, any of the models described above (e.g., regression models and artificial neural networks) can be combined to form an ensemble. As an example, an ensemble can include a top level machine-learned model or a heuristic function to combine and/or weight the outputs of the models that form the ensemble.

In some examples, multiple machine-learned models (e.g., that form an ensemble can be linked and trained jointly (e.g., through backpropagation of errors sequentially through the model ensemble). However, in some examples, only a subset (e.g., one) of the jointly trained models is used for inference.

In some examples, machine learning module 310 can be used to preprocess input data 333 for subsequent input into another model. For example, machine learning module 310 can perform dimensionality reduction techniques and embeddings (e.g., matrix factorization, principal components analysis, singular value decomposition, word2vec/GLOVE, and/or related approaches); clustering; and even classification and regression for downstream consumption.

As discussed above, machine learning module 310 can be trained or otherwise configured to receive input data 333 and, in response, provide output data 335. Input data 333 can include different types, forms, or variations of input data. As examples, in various implementations, input data 333 can include features that describe the content (or portion of content) initially selected by the user, e.g., content of user-selected document or image, links pointing to the user selection, links within the user selection relating to other files available on device or cloud, metadata of user selection, etc. Additionally, with user permission, input data 333 includes the context of user usage, either obtained from the app itself or from other sources. Examples of usage context include breadth of share (sharing publicly, or with a large group, or privately, or a specific person), context of share, etc. When permitted by the user, additional input data can include the state of the device, e.g., the location of the device, the apps running on the device, etc.

In some examples, machine learning module 310 can receive and use input data 333 in its raw form. In some examples, the raw input data can be preprocessed. Thus, in addition or alternatively to the raw input data, machine learning module 310 can receive and use the preprocessed input data.

In some examples, preprocessing input data 333 can include extracting one or more additional features from the raw input data. For example, feature extraction techniques can be applied to input data 333 to generate one or more new, additional features. Example feature extraction techniques include edge detection; corner detection; blob detection; ridge detection; scale-invariant feature transform; motion detection; optical flow; Hough transform; etc.

In some examples, the extracted features can include or be derived from transformations of input data 333 into other domains and/or dimensions. As an example, the extracted features can include or be derived from transformations of input data 333 into the frequency domain. For example, wavelet transformations and/or fast Fourier transforms can be performed on input data 333 to generate additional features.

In some examples, the extracted features can include statistics calculated from input data 333 or certain portions or dimensions of input data 333. Example statistics include the mode, mean, maximum, minimum, or other metrics of input data 333 or portions thereof.

In some examples, as described above, input data 333 can be sequential in nature. In some instances, the sequential input data can be generated by sampling or otherwise segmenting a stream of input data. As one example, frames can be extracted from a video. In some examples, sequential data can be made non-sequential through summarization.

As another example preprocessing technique, portions of input data 333 can be imputed. For example, additional synthetic input data can be generated through interpolation and/or extrapolation.

As another example preprocessing technique, some or all of input data 333 can be scaled, standardized, normalized, generalized, and/or regularized. Example regularization techniques include ridge regression; least absolute shrinkage and selection operator (LASSO); elastic net; least-angle regression; cross-validation; L1 regularization; L2 regularization; etc. As one example, some or all of input data 333 can be normalized by subtracting the mean across a given dimension's feature values from each individual feature value and then dividing by the standard deviation or other metric.

As another example preprocessing technique, some or all or input data 333 can be quantized or discretized. In some cases, qualitative features or variables included in input data 333 can be converted to quantitative features or variables. For example, one hot encoding can be performed.

In some examples, dimensionality reduction techniques can be applied to input data 333 prior to input into machine learning module 310. Several examples of dimensionality reduction techniques are provided above, including, for example, principal component analysis; kernel principal component analysis; graph-based kernel principal component analysis; principal component regression; partial least squares regression; Sammon mapping; multidimensional scaling; projection pursuit; linear discriminant analysis; mixture discriminant analysis; quadratic discriminant analysis; generalized discriminant analysis; flexible discriminant analysis; autoencoding; etc.

In some examples, during training, input data 333 can be intentionally deformed in any number of ways to increase model robustness, generalization, or other qualities. Example techniques to deform input data 333 include adding noise; changing color, shade, or hue; magnification; segmentation; amplification; etc.

In response to receipt of input data 333, machine learning module 310 can provide output data 335. Output data 335 can include different types, forms, or variations of output data. As examples, in various implementations, output data 335 can include content, either stored locally on the user device or in the cloud, that is relevantly shareable along with the initial content selection.

As discussed above, in some examples, output data 335 can include various types of classification data (e.g., binary classification, multiclass classification, single label, multi-label, discrete classification, regressive classification, probabilistic classification, etc.) or can include various types of regressive data (e.g., linear regression, polynomial regression, nonlinear regression, simple regression, multiple regression, etc.). In other instances, output data 335 can include clustering data, anomaly detection data, recommendation data, or any of the other forms of output data discussed above.

In some examples, output data 335 can influence downstream processes or decision making. As one example, in some examples, output data 335 can be interpreted and/or acted upon by a rules-based regulator.

Any of the different types or forms of input data described herein can be combined with any of the different types or forms of machine-learned models described herein to provide any of the different types or forms of output data described herein.

The systems and methods of the present disclosure can be implemented by or otherwise executed on one or more computing devices. Example computing devices include user computing devices (e.g., laptops, desktops, and mobile computing devices such as tablets, smartphones, wearable computing devices, etc.); embedded computing devices (e.g., devices embedded within a vehicle, camera, image sensor, industrial machine, satellite, gaming console or controller, or home appliance such as a refrigerator, thermostat, energy meter, home energy manager, smart home assistant, etc.); server computing devices (e.g., database servers, parameter servers, file servers, mail servers, print servers, web servers, game servers, application servers, etc.); dedicated, specialized model processing or training devices; virtual computing devices; other computing devices or computing infrastructure; or combinations thereof. A computing system that implements machine learning module 310 or other aspects of the present disclosure may include a number of hardware components that enable the performance of the techniques described herein.

In some instances, output data 335 obtained through machine learning module 310 at a computing system or device can be used to improve other device tasks or can be used by other non-user devices to improve services performed by or for such other non-user devices. For example, output data 335 can improve other downstream processes performed by a server device for a computing device of a user or embedded computing device. In other instances, output data 335 obtained through implementation of machine learning module 310 at a computing system or device can be sent to and used by a user computing device, an embedded computing device, or some other client device. In some examples, computing system 200 of FIG. 2 may perform machine learning as a service.

In yet other implementations, different respective portions of machine learning module 310 can be stored at and/or implemented by some combination of a user computing device; an embedded computing device; a server computing device; etc. In other words, portions of machine learning module 310 may be distributed in whole or in part amongst a client device (e.g., computing device 102 of FIG. 1) and a computing system (e.g., computing system 100 of FIG. 1).

A computing device such as computing device 102 of FIG. 1 may perform graph processing techniques or other machine learning techniques using one or more machine learning platforms, frameworks, and/or libraries, such as, for example, TensorFlow, Caffe/Caffe2, Theano, Torch/PyTorch, MXnet, CNTK, etc.

In some examples, multiple instances of machine learning module 310 can be parallelized to provide increased processing throughput. For example, the multiple instances of machine learning module 310 can be parallelized on a single processing device or computing device or parallelized across multiple processing devices or computing devices.

A computing device that implements machine learning module 310 or other aspects of the present disclosure can include a number of hardware components that enable performance of the techniques described herein. For example, a computing device can include one or more memory devices that store some or all of machine learning module 310. For example, machine learning module 310 can be a structured numerical representation that is stored in memory. The one or more memory devices can also include instructions for implementing machine learning module 310 or performing other operations. Example memory devices include RAM, ROM, EEPROM, EPROM, flash memory devices, magnetic disks, etc., and combinations thereof.

A computing device can also include one or more processing devices that implement some or all of machine learning module 310 and/or perform other related operations. Example processing devices include one or more of: a central processing unit (CPU); a visual processing unit (VPU); a graphics processing unit (GPU); a tensor processing unit (TPU); a neural processing unit (NPU); a neural processing engine; a core of a CPU, VPU, GPU, TPU, NPU or other processing device; an application specific integrated circuit (ASIC); a field programmable gate array (FPGA); a co-processor; a controller; or combinations of the processing devices described above. Processing devices can be embedded within other hardware components such as, for example, an image sensor, accelerometer, etc.

Hardware components (e.g., memory devices and/or processing devices) can be spread across multiple physically distributed computing devices and/or virtually distributed computing systems.

In some examples, machine learning module 310 described herein can be included in different portions of computer-readable code on a computing device. In one example, machine learning module 310 can be included in a particular application or program and used (e.g., exclusively) by such a particular application or program. Thus, in one example, a computing device can include a number of applications and one or more of such applications can contain its own respective machine learning library and machine-learned model(s).

In another example, machine learning module 310 described herein can be included in an operating system of a computing device (e.g., in a central intelligence layer of an operating system) and can be called or otherwise used by one or more applications that interact with the operating system. In some examples, each application can communicate with the central intelligence layer (and model(s) stored therein) using an application programming interface (API) (e.g., a common, public API across all applications).

In some examples, the central intelligence layer can communicate with a central device data layer. The central device data layer can be a centralized repository of data for the computing device. The central device data layer can communicate with a number of other components of the computing device, such as, for example, one or more sensors, a context manager, a device state component, and/or additional components. In some examples, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination.

Databases and applications can be implemented on a single system or distributed across multiple systems. Distributed components can operate sequentially or in parallel.

In addition, the machine learning techniques described herein are readily interchangeable and combinable. Although certain example techniques have been described, many others exist and can be used in conjunction with aspects of the present disclosure.

Further to the descriptions above, a user may be provided with controls that enable the user to make an election as to both if and when systems, programs or features described herein may enable collection of user information (e.g., information about a user's social network, social actions or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

FIG. 3C is a conceptual diagram illustrating a machine learning module configured to apply a large language model to various multimodal inputs to generate outputs associated with one or more applications, in accordance with one or more aspects of the present disclosure.

Machine learning module 310 of FIG. 3C may be an example of machine learning module 310 of FIGS. 3A and 3B. In general, ML module 310 can be or include one or more transformer-based neural networks, such as a large language model module 342. In general, language model module 342 may apply an LLM to multimodal input to identify one or more tasks. In some examples, language model module 342 may apply an LLM to other information stored by the computing system (e.g., retrieved application data, context information, etc.) to determine, for each of the one or more tasks, one or more associated applications, in which each of the one or more associated applications includes one or more functions for performing a respective task.

Language model module 342 may implement, for example, the Pathways Language Model developed by Google. Transformer-based neural networks may refer to a type of deep learning architecture specifically designed for handling sequential data, such as text or time series. In other words, transformer-based neural networks like LLMs may be configured to perform natural language processing (NLP) tasks, such as question-answering, machine translation, text summarization, and sentiment analysis. Language model module 342 may be configured to perform tasks such as classification, sentiment analysis, entity extraction, extractive question answering, summarization, re-writing text in a different style, ad copy generation, and concept ideation.

Transformer-based neural networks may utilize a self-attention mechanism, which allows the model to weigh the importance of different elements in a given input sequence relative to each other. The self-attention mechanism may help language model module 342 effectively capture long-range dependencies and complex relationships between elements, such as words in a sentence.

Language model module 342 may include an encoder and a decoder that operate to process and generate sequential data, such as structured text. Both the encoder and decoder may include one or more of self-attention mechanisms, position-wise feedforward networks, layer normalization, or residual connections. In some examples, the encoder may process an input sequence and create a representation that captures the relationships and context among the elements in the sequence. The decoder may then obtain the representation generated by the encoder and produce an output sequence. In some examples, the decoder may generate the output one element at a time (e.g., one word at a time), using a process called autoregressive decoding, where the previously generated elements are used as input to predict the next element in the sequence.

In some examples, language model module 342 may determine a set of information types included in the input. An information type may be or otherwise include a topic, theme, point, subject, purpose, intent, keyword, etc. In some examples, language model module 342 may determine the information type by leveraging a self-attention mechanism to capture the relationships and dependencies between words in the input sequence. For example, language model module 342 may tokenize (e.g., split) a sequence of words or subwords, which language model module 342 may convert into vectors (e.g., numerical representations) that language model module 342 can process. Language model module 342 may use the self-attention mechanism to weigh the importance of each token in relation to the others. In this way, language model module 342 may identify patterns and relationships between the tokens, and in turn the words corresponding to the tokens, that indicate one or more information types.

In general, language model module 342 may excel at performing NLP tasks, such as generating text and other content (e.g., new code that generates GUIs, graphical components, and/or functionality for performing one or more tasks). However, with respect to specific types of content (e.g., specific information types), language model module 342 may have an increased likelihood of generating false, inaccurate, or bad quality information. To address this issue, language model module 342 may be configured to exclude the generation of content or code relating to a set of excluded information types. For example, the set of excluded information types may include one or more of phone numbers, addresses, web addresses, functionality prohibited by an application, sensitive data (e.g., full bank account information), etc. Thus, input information may be passed in language model module 342 with certain prerequisites, prompts, or “rules” that can be stored in rules storage 344. Machine learning module 310 may apply these prerequisites, prompts, or rules when generating the set of instructions for generating the GUIs and graphical components associated with the functionality for performing the identified tasks.

In some examples, machine learning module 310 may use accessibility information when generating new code for GUIs and graphical components, such that the user can easily interact with the GUIs and graphical components. In some examples, the rules may be text inputs such as, for example, “Do not display more than 25 characters in a widget.” As such, rules storage 344 may store a plurality of text inputs and/or other data that further specify how instructions file 350 should be generated by machine learning module 310. For example, language model module 342 may be applied to the context information in accordance with the one or more predefined rules stored in rules storage 344, which may include, for example, unauthorized terms, unauthorized class names, unauthorized dimensions of the graphical user interface, unauthorized application functionality, etc. Because language model module 342 can interpret the rules along with the input, the computing system may provide more accurate instructions for generating GUIs, graphical components, and/or suggested data for performing identified tasks. In this way, the computing system may be able to interpret context information to identify a user's tasks, and then write or generate, at machine speed, new, robust, working code that can render new graphical user interfaces and/or components performing the identified tasks.

While language model module 342 may be a transformer-based neural network in some examples, in some other examples, language model module 342 may be or otherwise include one or more other types of neural networks. For example, language model module 342 may be or include an autoencoder. In some examples, the aim of an autoencoder is to learn a representation (e.g., a lower-dimensional encoding) for a set of data, typically for the purpose of dimensionality reduction. For example, in some examples, an autoencoder can seek to encode the input data and then provide output data that reconstructs the input data from the encoding. In some examples, the autoencoder can include additional losses beyond reconstructing the input data. Language model module 342 may be or include one or more other forms of artificial neural networks such as, for example, deep Boltzmann machines, deep belief networks, stacked autoencoders, etc. Any of the neural networks described herein can be combined (e.g., stacked) to form more complex networks.

Generally, large language models can be slow and expensive in terms of carbon, energy usage, and financial cost. Thus, in some examples, machine learning module 310 may minimize how often language model module 342 is invoked by caching generated instructions, or new code, in instructions cache 348. For example, in some examples, language model module 342 may use a prompt including the context information retrieved by the computing system. At runtime, more specific details may be gathered (e.g., via the API), such that the generated instructions or code may be reused. Specifically, machine learning module 310 may be configured to perform instruction embedding in which a representation (i.e., embedding) of frequently used or critical instructions are stored in instructions cache 348.

In various examples, instructions file 350 may be generated based on the instructions stored in instructions cache 348 and any additional instructions, information, or updates retrieved by the API that are not present in instructions cache 348. For example, instructions storage 229 of FIG. 2 or any other local memory may store these additional instructions, information, or updates retrieved by API module 203. Machine learning module 310 may query instructions storage 229 or other local memory to gather these additional instructions, information, or updates and use them with the cached instructions at runtime to generate instructions file 350.

By storing frequently used or critical instructions in instructions cache 348, machine learning module 310 may reuse the frequently used or critical instructions without having to invoke language model module 342 on data other than what is included in new context information or input (e.g., language model module 342 may not have to re-apply the large language model to all stored context information). In some examples, machine learning module 310 may apply code caching to both compiled and interpreted languages. Machine learning module 310 may implement various types of caching, such as, for example, Just-In-Time (JIT) compilation, Ahead-Of-Time (AOT) compilation, and bytecode caching.

In some examples, instructions file 350 may include all data collected or used by the computing system to generate instructions file 350. For example, instructions file 350 may include details for how the user's natural language was resolved into working code. In some examples, users may be able to view or “inspect” instructions file 350. In other words, a user may be provided various controls to clarify, inspect, or stop a task to ensure that the computing system is following the user's intent. Thus, the generated user interfaces and/or graphical components may be inspectable, in which users can, for example, interact with widgets to see the associated data, code or instructions (e.g., instructions file 350), or pinch to expand widgets to reveal more controls. Furthermore, a user may be able to edit instructions file 350. For example, a user may edit the parameters used by machine learning module 310, and the code included in instructions file 350 may update to reflect the edits. Furthermore, in some examples, users may interact with the GUIs and/or graphical components to add or delete GUIs and/or graphical components, directly edit parameters, edit the order of the GUIs, the arrangement of the graphical components, change, add, or delete visual effects, etc. As such, any predetermined or suggested data determined by machine learning module 310, the instructions for generating the GUIs, graphical components, associated application overlay GUIs, and any other data included in instructions file 350 may be customizable or user configurable. However, it should be noted that in some examples, certain instructions may not be inspectable and/or editable by users, such as those pertaining to certain graphical elements included in associated application overlay GUIs (e.g., trademarked symbols), and one or more functions included in the associated applications (e.g., a user may not edit a banking application's functionality for transferring funds).

By leveraging one or more of the machine learning techniques described herein, and by leveraging code caching, the user interface generation provided by the computing system may require less time and/or computational resources to create new GUIs and graphical components for performing a user's identified tasks.

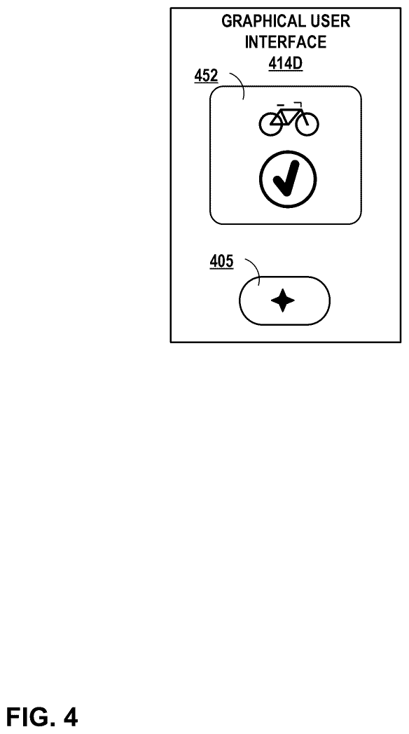

FIG. 4 is a conceptual diagram illustrating an example of output associated with one or more applications, in accordance with one or more aspects of the present disclosure. In the example of FIG. 4, GUI 414D may be another view of the single GUI of FIG. 1, e.g., a home screen GUI, that is updated or transitions based on the gestures and/or multimodal input provided by a user, e.g., by the user interacting with universally accessible button 405. For example, GUI 414D may be an example view of a home screen GUI displaying output generated by the computing system based on the multimodal input provided by the user. For example, continuing the multimodal input example of FIG. 1, in which the computing system receives an indication of a natural language user input such as “Unlock bike,” and an indication of an image input including a code for unlocking the bike, the computing system may apply one or more machine learning models to the multimodal input to identify a task of unlocking a bike. Then, the computing system may apply the one or more machine learning models to the multimodal input (and additionally, in some examples, information retrieved by the computing system from applications installed at the computing system or a user's device) to identify at least one application including at least one function for performing the task. That is, the computing system may identify a bike rental application installed on the user's device that includes functionality for electronically unlocking a bike by entering a code. In some examples, the computing system may execute, based on the indication of the natural language user input and the indication of the image input, the at least one application to perform the task. That is, in this example, the computing system may use the bike rental application API to provide, for example, the code as input to the application, and receive, for example, data associated with the application, such as application GUI data. Then, the computing system may generate, for display at a display device (such as UID 104 of FIG. 1), at least one output associated with the at least one application, such as graphical component 452 that is associated with the bike rental application. As shown in the example of FIG. 4, graphical component 452 may be a graphical component that indicates the bike has been successfully unlocked (e.g., by including a bike icon and a check mark icon).

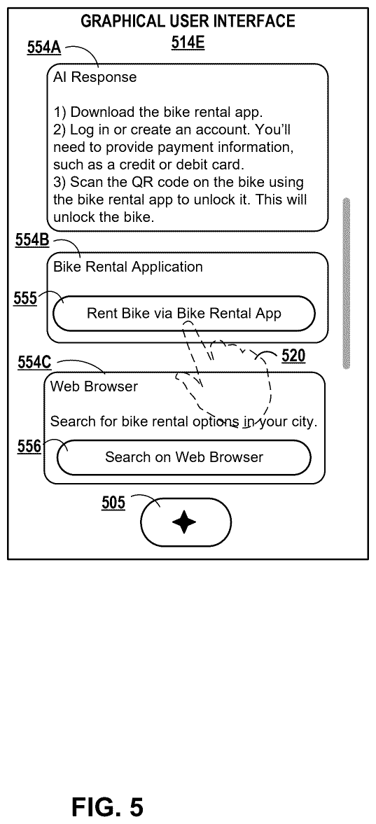

FIG. 5 is a conceptual diagram illustrating another example of output associated with one or more applications, in accordance with one or more aspects of the present disclosure. In the example of FIG. 5, GUI 514E may be another view of the single GUI of FIG. 1, e.g., a home screen GUI, that is updated or transitions based on the gestures and/or multimodal input provided by a user, e.g., by the user interacting with universally accessible button 505. For example, GUI 514E may be another example view of a home screen GUI displaying other example output generated by the computing system based on the multimodal input provided by the user. For example, continuing the multimodal input example of FIG. 1, in which the computing system receives an indication of a natural language user input such as “Unlock bike,” and an indication of an image input including a code for unlocking the bike, the computing system may identify a plurality of applications, in which each application from the plurality of applications includes at least one function for performing the task of unlocking a bike. As shown in the example of FIG. 5, the at least one output may include a plurality of graphical components such as widgets 554A-554C, in which each graphical component is associated with a respective application from the plurality of applications.

For example, in the example of FIG. 5, widget 554A may be associated with a machine learning application that generates an artificial intelligence (AI) response that includes information for performing a task. As shown, based on a task of unlocking a bike, the AI response may include the following instructions displayed as text within widget 554A:
“1) Download the bike rental app. 2) Log in or create an account. You'll need to provide payment information, such as a credit or debit card. 3) Scan the QR code on the bike using the bike rental app to unlock it. This will unlock the bike.” As such, in some examples, the output generated by the computing system based on the multimodal input provided by the user may be a widget including text output, in which the text output is a natural language response generated, for example, by an LLM.

Widget 554B, for example, may be associated with a bike rental application installed at the user's computing device. As shown in the example of FIG. 5, widget 554B may include button 555, “Rent Bike via Bike Rental App,” which user 520 may interact with to launch the bike rental app. Widget 554C, for example, may be associated with a web browser, and may include button 556, “Search on Web Browser,” which user 520 may interact with to launch the web browser. As such, in general, the output generated by the computing system may include one or more of graphical components (e.g., widgets) that are each associated with a respective application and suggested actions for a respective application (e.g., renting a bike via the bike rental application or searching the web browser for bike rental applications in the user's city).

In some examples, each respective application is assigned a respective level of relevance, in which a display of the plurality of graphical components at the display device is based on the respective level of relevance. That is, in the example of FIG. 5, widgets 554A-554C may be positioned within GUI 514E based on a respective level of relevance determined for the machine learning application, the bike rental application, and the web browser application. For example, the computing system may apply one or more machine learning models to retrieved information that indicates, for example, historical user data, user interaction data for each of the applications, user preference data, etc. In the example of FIG. 5, widget 554A may be positioned at a top portion of GUI 514E based on, for example, a user's preference for always receiving an AI response, and widget 554B may be positioned above widget 554C based on, for example, the user frequently interacting with the bike rental application to perform the task of unlocking a bike. As shown in the example of FIG. 5, GUI 514E may be scrollable and may include additional widgets for additional applications (not shown) that are determined to have lower levels of relevance than that of the applications associated with widgets 554A-554C.

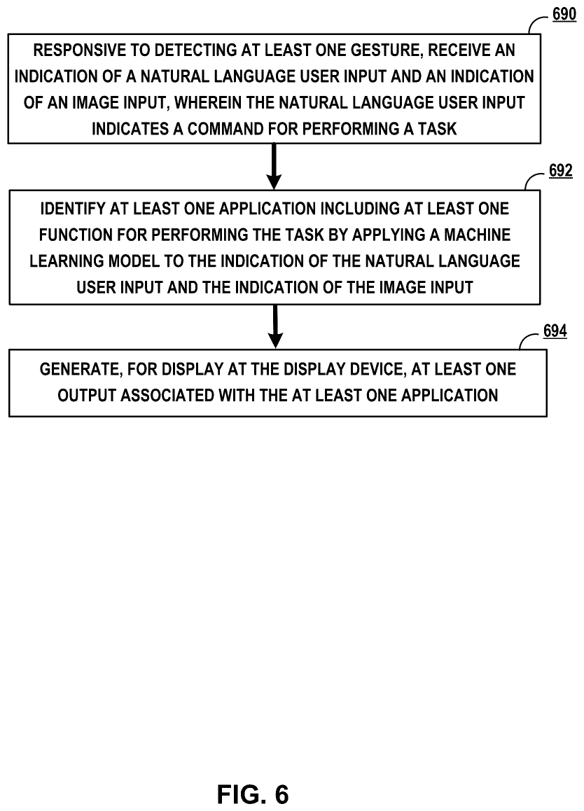

FIG. 6 is a flowchart illustrating example operations for receiving multimodal input and applying a large language model to the multimodal input to generate outputs associated with one or more applications, in accordance with one or more aspects of the present disclosure. For clarity, FIG. 6 is described with respect to FIGS. 1-5.

In general, computing system 100 may output, for display at UID 104, one or more of GUIs 114 that include a plurality of user interface elements, such as GUI 114A that includes universally accessible button 105, GUI 114B that includes widget 109 and UI element 107, and GUI 114C that includes visual indication 111 including an animation of a graphical element indicative of functionality for receiving an image input. Responsive to detecting at least one gesture (e.g., at one or more locations of GUIs 114), computing system 100 receives an indication of natural language user input 118 and an indication of image input 117, in which natural language user input 118 indicates a command for performing a task (690). In some examples, the at least one gesture includes at least a first gesture and a second gesture. In some examples, responsive to detecting a first gesture (e.g., user 122 performing a first tactile event at location 120A of GUI 114A that corresponds to button 105), computing system 100 receives the indication of natural language user input 118. In some examples, responsive to detecting a second gesture (e.g., user 122 performing a second tactile event by dragging their finger from location 120A to location 120B in the direction of path 121 to select UI element 107 of GUI 114B), computing system 100 outputs, for display at UID 104, GUI 114C including visual indication 111 of receiving image input 117. In some examples, the at least one gesture further includes at least a third gesture (e.g., user 122 may provide a last tactile event, i.e., a termination event, such as lifting their finger off the screen, which is represented by transition 123), and responsive to detecting the third gesture, computing system 100 receives the indication of image input 117. In some examples, the at least one gesture is a single, continuous gesture.

Computing system 100 identifies at least one application including at least one function for performing the task by applying machine learning module 110 to the indication of natural language user input 118 and the indication of image input 117 (692). In some examples, machine learning module 110 includes language model module 342. In some examples, computing system 100 executes, based on the indication of natural language user input 118 and the indication of image input 117, the at least one application to perform the task.

Computing system 100 generates, for display at UID 104, at least one output associated with the at least one application (694). In some examples, the at least one application includes a plurality of applications, in which each application from the plurality of applications includes at least one function for performing the task. In some examples, the at least one output includes a plurality of graphical components, such as widgets 554A-554C, in which each graphical component from the plurality of graphical components is associated with a respective application from the plurality of applications. In some examples, the at least one output includes one or more of a graphical component associated with the at least one application (e.g., graphical component 452 and/or widgets 554A-554C) and a suggested action for the at least one application (e.g., buttons 555 and 556 indicative of suggested actions for a respective application). In some examples, each respective application is assigned a respective level of relevance, and a display of the plurality of graphical components, such as widgets 554A-554C, is based on the respective level of relevance.

As such, the techniques described in this disclosure may enable users to seamlessly provide multimodal input through a single, continuous gesture (e.g., including a combination of a press action, swipe actions, a lift off action, etc.) detected at a user's device, e.g., at a location of a GUI that corresponds to a universally accessible button. That is, to perform various tasks or receive various answers to queries (e.g., suggested actions, relevant application results for a user query, etc.) users may not be required to switch between multiple applications to gather information and/or input, and instead may provide multimodal input through interaction with the single, universally accessible button. In this way, the techniques described in this disclosure may help users perform tasks more efficiently, and thus improve overall user experience with devices.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of intraoperative hardware units, including one or more processors as described above, in conjunction with suitable software and/or firmware.

This disclosure includes the following examples:

Example 1: A method includes responsive to detecting at least one gesture, receiving, by a computing system, an indication of a natural language user input and an indication of an image input, wherein the natural language user input indicates a command for performing a task; identifying, by the computing system, at least one application including at least one function for performing the task by applying a machine learning model to the indication of the natural language user input and the indication of the image input; and generating, by the computing system and for display at a display device, at least one output associated with the at least one application.

Example 2: The method of example 1, wherein the at least one gesture includes at least a first gesture and a second gesture, the method further includes outputting, by the computing system, and for display at a display device, a graphical user interface including a plurality of user interface elements; responsive to detecting the first gesture at a location of the graphical user interface that corresponds to a first user interface element from the plurality of user interface elements, receiving, by the computing system, the indication of the natural language user input; and responsive to detecting the second gesture at a location of the graphical user interface that corresponds to a second user interface element from the plurality of user interface elements, outputting, by the computing system and for display at the display device, a visual indication of receiving the image input.

Example 4: The method of example 2, wherein the visual indication includes an animation of a graphical element indicative of functionality for receiving the image input.

Example 5: The method of any of examples 1 through 3, further includes executing, by the computing system, and based on the indication of the natural language user input and the indication of the image input, the at least one application to perform the task.

Example 6: The method of any of examples 1 through 4, wherein the at least one output includes one or more of: a graphical component associated with the at least one application, and a suggested action for the at least one application.

Example 7: The method of any of examples 1 through 5, wherein the at least one application includes a plurality of applications, wherein each application from the plurality of applications includes at least one function for performing the task, wherein the at least one output includes a plurality of graphical components, and wherein each graphical component from the plurality of graphical components is associated with a respective application from the plurality of applications.

Example 8: The method of example 7, wherein each respective application is assigned a respective level of relevance, and wherein a display of the plurality of graphical components at the display device is based on the respective level of relevance.

Example 9: The method of any of examples 1 through 7, wherein the at least one gesture is a single, continuous gesture.

Example 10: The method of any of examples 1 through 8, wherein the machine learning model is a large language model.

Example 11: A computing system includes at least one processor; a display device; and at least one storage device that stores instructions, that, when executed by the at least one processor, cause the at least one processor to: responsive to detecting at least one gesture, receive an indication of a natural language user input and an indication of an image input, wherein the natural language user input indicates a command for performing a task; identify at least one application including at least one function for performing the task by applying a machine learning model to the indication of the natural language user input and the indication of the image input; and generate, for display at the display device, at least one output associated with the at least one application.

Example 12: The computing system of example 11, wherein the at least one gesture includes at least a first gesture and a second gesture, wherein the instructions further cause the at least one processor to: output, for display at the display device, a graphical user interface including a plurality of user interface elements; responsive to detecting the first gesture at a location of the graphical user interface that corresponds to a first user interface element from the plurality of user interface elements, receive the indication of the natural language user input; and responsive to detecting the second gesture at a location of the graphical user interface that corresponds to a second user interface element from the plurality of user interface elements, output, for display at the display device, a visual indication of receiving the image input.

Example 13: The computing system of example 12, wherein the at least one gesture further includes at least a third gesture, wherein the instructions further cause the at least one processor to: responsive to detecting the third gesture at a location of the graphical user interface that corresponds to the visual indication, receive the indication of the image input.

Example 14: The computing system of example 12, wherein the visual indication includes an animation of a graphical element indicative of functionality for receiving the image input.

Example 15: The computing system of any of examples 11 through 13, wherein the instructions further cause the at least one processor to: execute, based on the indication of the natural language user input and the indication of the image input, the at least one application to perform the task.

Example 16: The computing system of any of examples 11 through 14, wherein the at least one output includes one or more of: a graphical component associated with the at least one application, and a suggested action for the at least one application.

Example 17: The computing system of any of examples 11 through 15, wherein the at least one application includes a plurality of applications, wherein each application from the plurality of applications includes at least one function for performing the task, wherein the at least one output includes a plurality of graphical components, and wherein each graphical component from the plurality of graphical components is associated with a respective application from the plurality of applications.

Example 18: The computing system of example 17, wherein each respective application is assigned a respective level of relevance, and wherein a display of the plurality of graphical components at the display device is based on the respective level of relevance.

Example 19: The computing system of any of examples 11 through 17, wherein the at least one gesture is a single, continuous gesture.

Example 20: The computing system of any of examples 11 through 18, wherein the machine learning model is a large language model.

Example 21: A non-transitory computer-readable storage medium encoded with instructions that, when executed by at least one processor, cause the at least one processor to: responsive to detecting at least one gesture, receive an indication of a natural language user input and an indication of an image input, wherein the natural language user input indicates a command for performing a task; identify at least one application including at least one function for performing the task by applying a machine learning model to the indication of the natural language user input and the indication of the image input; and generate, for display at a display device, at least one output associated with the at least one application.

Example 22: The non-transitory computer-readable storage medium of example 21, wherein the at least one gesture includes at least a first gesture and a second gesture, wherein the instructions further cause the at least one processor to: output, for display at the display device, a graphical user interface including a plurality of user interface elements; responsive to detecting the first gesture at a location of the graphical user interface that corresponds to a first user interface element from the plurality of user interface elements, receive the indication of the natural language user input; and responsive to detecting the second gesture at a location of the graphical user interface that corresponds to a second user interface element from the plurality of user interface elements, output, for display at the display device, a visual indication of receiving the image input.

Example 23: The non-transitory computer-readable storage medium of example 22, wherein the at least one gesture further includes at least a third gesture, wherein the instructions further cause the at least one processor to: responsive to detecting the third gesture at a location of the graphical user interface that corresponds to the visual indication, receive the indication of the image input.

Example 24: The non-transitory computer-readable storage medium of example 22, wherein the visual indication includes an animation of a graphical element indicative of functionality for receiving the image input.

Example 25: The non-transitory computer-readable storage medium of any of examples 21 through 23, wherein the instructions further cause the at least one processor to: execute, based on the indication of the natural language user input and the indication of the image input, the at least one application to perform the task.

Example 26: The non-transitory computer-readable storage medium of any of examples 21 through 24, wherein the at least one output includes one or more of: a graphical component associated with the at least one application, and a suggested action for the at least one application.

Example 27: The non-transitory computer-readable storage medium of any of examples 21 through 25, wherein the at least one application includes a plurality of applications, wherein each application from the plurality of applications includes at least one function for performing the task, wherein the at least one output includes a plurality of graphical components, and wherein each graphical component from the plurality of graphical components is associated with a respective application from the plurality of applications.

Example 28: The non-transitory computer-readable storage medium of example 27, wherein each respective application is assigned a respective level of relevance, and wherein a display of the plurality of graphical components at the display device is based on the respective level of relevance.

Example 29: The non-transitory computer-readable storage medium of any of examples 21 through 27, wherein the at least one gesture is a single, continuous gesture.

Example 30: The non-transitory computer-readable storage medium of any of examples 21 through 28, wherein the machine learning model is a large language model.

Example 31: A computer program product for generating output based on received multimodal input, the computer program product comprising instructions that, when executed by at least one processor, cause the at least one processor to: responsive to detecting at least one gesture, receive an indication of a natural language user input and an indication of an image input, wherein the natural language user input indicates a command for performing a task; identify at least one application including at least one function for performing the task by applying a machine learning model to the indication of the natural language user input and the indication of the image input; and generate, for display at a display device, at least one output associated with the at least one application.

Example 32: The computer program product of example 31, wherein the at least one gesture includes at least a first gesture and a second gesture, wherein the instructions further cause the at least one processor to: output, for display at the display device, a graphical user interface including a plurality of user interface elements; responsive to detecting the first gesture at a location of the graphical user interface that corresponds to a first user interface element from the plurality of user interface elements, receive the indication of the natural language user input; and responsive to detecting the second gesture at a location of the graphical user interface that corresponds to a second user interface element from the plurality of user interface elements, output, for display at the display device, a visual indication of receiving the image input.

Example 33: The computer program product of example 32, wherein the at least one gesture further includes at least a third gesture, wherein the instructions further cause the at least one processor to: responsive to detecting the third gesture at a location of the graphical user interface that corresponds to the visual indication, receive the indication of the image input.

Example 34: The computer program product of example 32, wherein the visual indication includes an animation of a graphical element indicative of functionality for receiving the image input.

Example 35: The computer program product of any of examples 31 through 34, wherein the instructions further cause the at least one processor to: execute, based on the indication of the natural language user input and the indication of the image input, the at least one application to perform the task.

Example 36: The computer program product of any of examples 31 through 35, wherein the at least one output includes one or more of: a graphical component associated with the at least one application, and a suggested action for the at least one application.

Example 37: The computer program product of any of examples 31 through 36, wherein the at least one application includes a plurality of applications, wherein each application from the plurality of applications includes at least one function for performing the task, wherein the at least one output includes a plurality of graphical components, and wherein each graphical component from the plurality of graphical components is associated with a respective application from the plurality of applications.

Example 38: The computer program product of example 37, wherein each respective application is assigned a respective level of relevance, and wherein a display of the plurality of graphical components at the display device is based on the respective level of relevance.

Example 39: The computer program product of any of examples 31 through 38, wherein the at least one gesture is a single, continuous gesture.

Example 40: The computer program product of any of examples 31 through 39, wherein the machine learning model is a large language model.

Example 41: A computing device comprising means for performing any combination of examples 1-10.

What is claimed is:

1. A method comprising:
responsive to detecting at least one gesture, receiving, by a computing system, an indication of a natural language user input and an indication of an image input, wherein the natural language user input indicates a command for performing a task;
identifying, by the computing system, at least one application including at least one function for performing the task by applying a machine learning model to the indication of the natural language user input and the indication of the image input; and
generating, by the computing system and for display at a display device, at least one output associated with the at least one application.

2. The method of claim 1, wherein the at least one gesture includes at least a first gesture and a second gesture, the method further comprising:
outputting, by the computing system, and for display at a display device, a graphical user interface including a plurality of user interface elements;
responsive to detecting the first gesture at a location of the graphical user interface that corresponds to a first user interface element from the plurality of user interface elements, receiving, by the computing system, the indication of the natural language user input; and
responsive to detecting the second gesture at a location of the graphical user interface that corresponds to a second user interface element from the plurality of user interface elements, outputting, by the computing system and for display at the display device, a visual indication of receiving the image input.

3. The method of claim 2, wherein the at least one gesture further includes at least a third gesture, the method further comprising:
responsive to detecting the third gesture at a location of the graphical user interface that corresponds to the visual indication, receiving, by the computing system, the indication of the image input.

4. The method of claim 2, wherein the visual indication includes an animation of a graphical element indicative of functionality for receiving the image input.

5. The method of claim 1, further comprising:
executing, by the computing system, and based on the indication of the natural language user input and the indication of the image input, the at least one application to perform the task.

6. The method of claim 1, wherein the at least one output includes one or more of:
a graphical component associated with the at least one application, and
a suggested action for the at least one application.

7. The method of claim 1, wherein the at least one application includes a plurality of applications, wherein each application from the plurality of applications includes at least one function for performing the task, wherein the at least one output includes a plurality of graphical components, and wherein each graphical component from the plurality of graphical components is associated with a respective application from the plurality of applications.

8. The method of claim 7, wherein each respective application is assigned a respective level of relevance, and wherein a display of the plurality of graphical components at the display device is based on the respective level of relevance.

9. The method of claim 1, wherein the at least one gesture is a single, continuous gesture.

10. A computing system comprising:
at least one processor;
a display device; and
at least one storage device that stores instructions, that, when executed by the at least one processor, cause the at least one processor to:
responsive to detecting at least one gesture, receive an indication of a natural language user input and an indication of an image input, wherein the natural language user input indicates a command for performing a task;
identify at least one application including at least one function for performing the task by applying a machine learning model to the indication of the natural language user input and the indication of the image input; and
generate, for display at the display device, at least one output associated with the at least one application.

11. The computing system of claim 10, wherein the at least one gesture includes at least a first gesture and a second gesture, wherein the instructions further cause the at least one processor to:
output, for display at the display device, a graphical user interface including a plurality of user interface elements;
responsive to detecting the first gesture at a location of the graphical user interface that corresponds to a first user interface element from the plurality of user interface elements, receive the indication of the natural language user input; and
responsive to detecting the second gesture at a location of the graphical user interface that corresponds to a second user interface element from the plurality of user interface elements, output, for display at the display device, a visual indication of receiving the image input.

12. The computing system of claim 11, wherein the at least one gesture further includes at least a third gesture, wherein the instructions further cause the at least one processor to:
responsive to detecting the third gesture at a location of the graphical user interface that corresponds to the visual indication, receive the indication of the image input.

13. The computing system of claim 11, wherein the visual indication includes an animation of a graphical element indicative of functionality for receiving the image input.

14. The computing system of claim 10, wherein the instructions further cause the at least one processor to:
execute, based on the indication of the natural language user input and the indication of the image input, the at least one application to perform the task.

15. The computing system of claim 10, wherein the at least one output includes one or more of:
a graphical component associated with the at least one application, and
a suggested action for the at least one application.

16. The computing system of claim 10, wherein the at least one application includes a plurality of applications, wherein each application from the plurality of applications includes at least one function for performing the task, wherein the at least one output includes a plurality of graphical components, and wherein each graphical component from the plurality of graphical components is associated with a respective application from the plurality of applications.

17. The computing system of claim 16, wherein each respective application is assigned a respective level of relevance, and wherein a display of the plurality of graphical components at the display device is based on the respective level of relevance.

18. The computing system of claim 10, wherein the at least one gesture is a single, continuous gesture.

19. A non-transitory computer-readable storage medium encoded with instructions that, when executed by at least one processor, cause the at least one processor to:
responsive to detecting at least one gesture, receive an indication of a natural language user input and an indication of an image input, wherein the natural language user input indicates a command for performing a task;
identify at least one application including at least one function for performing the task by applying a machine learning model to the indication of the natural language user input and the indication of the image input; and
generate, for display at a display device, at least one output associated with the at least one application.

20. The non-transitory computer-readable storage medium of claim 19, wherein the at least one gesture includes at least a first gesture and a second gesture, wherein the instructions further cause the at least one processor to:
output, for display at the display device, a graphical user interface including a plurality of user interface elements;
responsive to detecting the first gesture at a location of the graphical user interface that corresponds to a first user interface element from the plurality of user interface elements, receive the indication of the natural language user input; and
responsive to detecting the second gesture at a location of the graphical user interface that corresponds to a second user interface element from the plurality of user interface elements, output, for display at the display device, a visual indication of receiving the image input.
